(19) United States
(12) Patent Application Publication
(10) Pub. No.: US 2026/0317456 A1
(43) Pub. Date: Oct. 15, 2026

(54) LOW DENSITY POLETHYLENES, FILMS THEREOF, AND METHODS AND CATALYSTS FOR PRODUCTION THEREOF

(71) Applicant: EXXONMOBIL TECHNOLOGY AND ENGINEERING COMPANY, Spring, TX (US)

(72) Inventors: Matthew W. Holtcamp, Humble, TX (US); Dongming Li, Houston, TX (US); Laughlin G. McCullough, League City, TX (US); Kevin A. Stevens, Raritan, NJ (US); Michael A. Leaf, Baytown, TX (US); Ali H. Slim, Houston, TX (US)

(73) Assignee: EXXONMOBIL TECHNOLOGY AND ENGINEERING COMPANY, Spring, TX (US)

(21) Appl. No.: 19/485,593

(22) PCT Filed: May 14, 2024
(86) PCT No.: PCT/US2024/029261

§ 371 Date: Nov. 18, 2025

Related U.S. Application Data
(60) Provisional application No. 63/503,869, filed on May 23, 2023.

(51) Int. Cl. C08F 4/6592; B01J 31/16; C08F 210/16

(52) U.S. Cl. CPC C08F 4/65927; B01J 31/1616; C08F 210/16; B01J 2231/12; B01J 2531/48

(57) ABSTRACT

The present disclosure relates to catalysts, catalyst systems, polyethylene polymers, polymerization processes for making such polyethylene polymers, and films made therefrom. In some embodiments, a catalyst compound is represented by Formula (I) wherein M is Zr or Hf; R⁵ and R⁶ are each hydrogen; each of R¹, R², R³, and R⁴ is independently hydrogen or substituted or unsubstituted C₁ to C₁₀ alkyl; one of (1) R⁷ and R¹, (2) R⁸ and R⁹, or (3) R⁹ and R¹⁰ are joined to form a substituted or unsubstituted aromatic ring or saturated ring fused to the indenyl ring shown in Formula (I), and the remainder of R⁷, R⁸, R⁹, and R¹⁰ are each hydrogen. In other embodiments a process for producing a polyethylene composition is provided, comprising introducing, under first polymerization conditions, ethylene and a C₃-C₄₀ alpha-olefin to a catalyst system in a reactor, and forming a polyethylene composition.

### CROSS-REFERENCE TO RELATED APPLICATIONS

This application claims the benefit of U.S. Provisional Application 63/503,869, filed May 23, 2023, entitled “Low Density Polyethylenes, Films Thereof, And Methods And Catalysts For Production Thereof”, the entirety of which is incorporated by reference herein.

### FIELD

This disclosure relates to catalysts, catalyst systems, polyethylene polymers, polymerization processes for making such polyethylene polymers, and films made therefrom.

### BACKGROUND

In many cases, low density polyethylenes (LDPEs) (e.g., LDPE resins) are produced by free radical polymerization using autoclave or tubular reaction processes. Autoclave and tubular reaction processes differ notably in terms of at least reaction residence time distribution, which can affect LDPE properties. In an autoclave process, back mixing of reactant streams is significant while in a tubular process, a plug flow regime of reactant streams is characteristic. Both processes require high pressure processes, e.g., 60 MPa to 350 MPa to produce polyethylene compositions having good processability, high melt strength, high shrink, and good optical properties, mainly due to their extensive long chain branched LCB structure. However, LDPEs formed by high pressure free radical polymerizations typically suffer from poor mechanical properties such as low TD tear and dart impact strength. In addition, high pressure processes involve higher energy consumption than low pressure processes.

Alternatively, a linear low density polyethylene (LLDPE) is a substantially linear polymer composed of ethylene monomeric units and alpha-olefin comonomeric units. An LLDPE may be distinguished from a conventional LDPE in several ways including their different manufacturing processes and different rheological and mechanical properties, such as tear properties, as compared to LDPEs. However, LLDPEs often require more motor power and higher extruder pressures to match the extrusion rates of LDPEs.

In the past, LLDPEs have been modified in an attempt to strive for a good balance of stiffness, toughness, optical properties (e.g., haze and gloss) and processability. Such balance can be provided by some LLDPEs having a broad orthogonal compositional distribution (referred to as “BOCD”). These LLDPEs are typically prepared with a catalyst (mixed with one or more other components to form a catalyst system) which promotes polymerization of olefin monomers in a gas phase reactor at pressures lower than those required for LDPEs produced by high pressure free radical polymerizations. Such catalyst systems often include two or more different metallocene catalysts in order to obtain LLDPEs having, for example, BOCD properties. However, pairing different catalysts (in a single catalyst system) that perform optimally at similar/same conditions is challenging.

Overall, there is a need for new polyethylenes formed in lower pressure processes to generate LCB polyethylene compositions using a single catalyst, in which the LCB polyethylene composition exhibits good extrusion processability like LDPE, but also with good tear properties and Dart impact strength. Such new LCB polyethylene compositions would provide the benefits of increased processability with an increased tear balance, increased TD tear, and much better drawdown characteristics, making easier to produce thin gauge films.

Some references of potential interest in this regard include: U.S. Pat. Nos. 6,479,424; 7,601,666; 8,829,115; 9,068,033; 10,633,471; 11,267,917; and 11,352,386; WO2021/257264; WO2022/015094; US2006/0122342; US2021/0332169; US2021/0388191; US2021/0395404; US2022/0185916; US2022/0315680; US2022/0064344; KR10-2022-0009900, KR10-2022-0009782; KR10-2021-0080974; KR10-2021-0038379; KR10-2020-0089599; KR10-2018-0063669; KR10-2007-0098276; and Foster, et al., Journal of Organometallic Chemistry, 571 (1998) 171.

### SUMMARY

The present disclosure relates to support-bound activators, supported catalyst systems, and processes for use thereof.

In some embodiments, a catalyst compound represented by Formula (I):

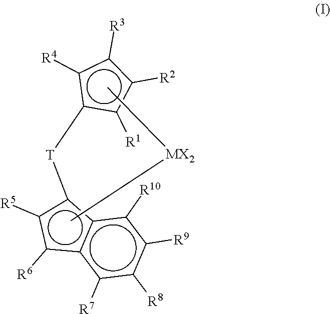

wherein M is Zr or Hf; R⁵ and R⁶ are each hydrogen; each of R¹, R², R³, and R⁴ is independently hydrogen or substituted or unsubstituted C₁ to C₁₀ alkyl; one of (1) R⁷ and R¹, (2) R⁸ and R⁹, or (3) R⁹ and R¹⁰ are joined to form a substituted or unsubstituted aromatic ring or saturated ring fused to the indenyl ring shown in Formula (I), and the remainder of R⁷, R⁸, R⁹, and R¹⁰ are each hydrogen; T is represented by formula R^{a}₂J, (R^{a})₄J₂, or (R^{a})₆J₃ wherein each J is independently carbon, silicon, or germanium, and each R^{a} is independently hydrogen, halide, a substituted or unsubstituted C₁ to C₄₀ hydrocarbyl, or two R^{a} can form a substituted or unsubstituted completely saturated ring, a substituted or unsubstituted partially saturated ring, or a substituted or unsubstituted aromatic ring; and each X is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene.

In some embodiments, a process for producing a polyethylene composition includes introducing, under first polymerization conditions, ethylene and a C₃-C₄₀ alpha-olefin with a catalyst system in a reactor and forming a polyethylene copolymer with ethylene monomer derived content and C₃-C₄₀ alpha-olefin comonomer derived content. The catalyst system includes a catalyst compound. The catalyst compound is represented by Formula (I):

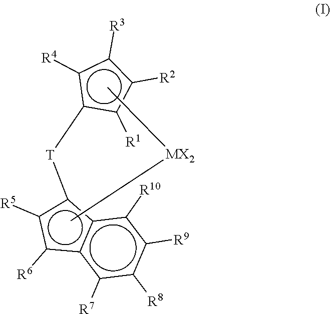

wherein M is a group 4 metal; each of R¹, R², R³, R⁴, R⁵, R⁶, R⁷, R⁸, R⁹, and R¹⁰ is independently hydrogen, a substituted or unsubstituted hydrocarbyl, a substituted or unsubstituted heteroatom, or a substituted or unsubstituted heteroatom-containing group, or one or more of R⁵ and R⁶, R⁷ and R⁸, R⁸ and R⁹, and R⁹ and R¹⁰ are joined to form a substituted or unsubstituted completely saturated ring or a substituted or unsubstituted aromatic ring, wherein at least one of (1) R⁷ and R⁸, (2) R⁸ and R⁹, or (3) R⁹ and R¹⁰ are joined to form a substituted or unsubstituted aromatic ring fused to the indenyl ring shown in Formula (I); T is represented by formula R^{a}₂J, (R^{a})₄J₂, or (R^{a})₆J₃ wherein each J is independently carbon, silicon, or germanium, and each R^{a} is independently hydrogen, halide, a substituted or unsubstituted C₁ to C₄₀ hydrocarbyl, or two R^{a} can form a substituted or unsubstituted completely saturated ring, a substituted or unsubstituted partially saturated ring, or a substituted or unsubstituted aromatic ring; and each X is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene.

In some embodiments, a film comprising a polyethylene copolymer, the polyethylene copolymer having a composition distribution breadth index (CDBI) of about 70% to about 80%, a density of about 0.914 g/cm³ to about 0.926 g/cm³, a melt index of about 0.10 g/10 min to about 6 g/10 min, an olefin comonomer content of about 5 wt % to about 12 wt %, a high load melt index (HLMI) of about 120 g/10 min to about 275 g/10 min, a melt index ratio (MIR) of about 60 to about 150, and a molecular weight distribution (MWD) of about 8 to about 12 is described herein.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a graph illustrating a TREFIR5 of polyethylene copolymers synthesized from Catalyst 1 compared to polyethylene copolymers synthesized from comparative catalysts.

FIG. 2 is a graph illustrating a complex viscosity of polyethylene copolymers synthesized from Catalyst 1 compared to polyethylene copolymers synthesized from comparative catalysts.

FIG. 3 is a graph illustrating a shear thinning index of polyethylene copolymers synthesized from Catalyst 1 compared to polyethylene copolymers synthesized from comparative catalysts.

FIG. 4 is a graph illustrating a phase angle versus complex modulus of polyethylene copolymers synthesized from Catalyst 1) compared to polyethylene copolymers synthesized from comparative catalysts.

FIG. 5 is a graph illustrating a phase angle (at 10 kPa) of polyethylene copolymers synthesized from Catalyst 1 compared to polyethylene copolymers synthesized from comparative catalysts.

### DEFINITIONS

For the purposes of the present disclosure, the numbering scheme for the Periodic Table Groups is used as described in Chemical and Engineering News, 63(5), pg. 27 (1985).

The following abbreviations may be used herein: Me is methyl, Et is ethyl, Ph is phenyl, PDI is polydispersity index, MAO is methylalumoxane, SMAO is supported methylalumoxane, NMR is nuclear magnetic resonance, ppm is part per million, THF is tetrahydrofuran.

The term “alkenyl” means a straight-chain, branched-chain, or cyclic hydrocarbon radical having one or more double bonds. These alkenyl radicals may be optionally substituted. Examples of suitable alkenyl radicals can include ethenyl, propenyl, allyl, 1,4-butadienyl, cyclopropenyl, cyclobutenyl, cyclopentenyl, cyclohexenyl, cycloctenyl, including their substituted analogues.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl. The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxyl.

The terms “alkyl radical,” “alkyl group,” and “alkyl” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, including their substituted analogues. Some examples of alkyl may include 1-methylethyl, 1-methylpropyl, 1-methylbutyl, 1-ethylbutyl, 1,3-dimethylbutyl, 1-methyl-1-ethylbutyl, 1,1-diethylbutyl, 1-propylpentyl, 1-phenylethyl, i-propyl, 2-butyl, sec-pentyl, sec-hexyl, and the like.

The term “alpha-olefin” refers to an olefin having a terminal carbon-to-carbon double bond in the structure thereof ((R″R′″)—C═CH₂, where R″ and R′″ can be independently hydrogen or any hydrocarbyl group, such as R″ is hydrogen and R′″ is an alkyl group). A “linear alpha-olefin” is an alpha-olefin defined in this paragraph wherein R″ is hydrogen, and R′″ is hydrogen or a linear alkyl group.

For the purposes of the present disclosure, ethylene shall be considered an alpha-olefin.

An “anionic ligand” is a negatively charged ligand which donates one or more pairs of electrons to a metal ion. A “Lewis base” or “neutral donor ligand” is a neutrally charged ligand which donates one or more pairs of electrons to a metal ion. Examples of Lewis bases include ethylether, trimethylamine, pyridine, tetrahydrofuran, dimethylsulfide, and triphenylphosphine. The term “heterocyclic Lewis base” refers to Lewis bases that are also heterocycles. Examples of heteroyclic Lewis bases include pyridine, imidazole, thiazole, and furan.

The term “arenyl” ligand is used herein to mean an unsaturated cyclic hydrocarbyl ligand that can consist of one ring, or two or more fused or catenated rings.

The term “aryl” or “aryl group” means an aromatic ring and the substituted variants thereof, such as phenyl, 2-methyl-phenyl, xylyl, 4-bromo-xylyl. Likewise, “heteroaryl” means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

A “bulk polymerization” means a polymerization process in which the monomers and or comonomers being polymerized are used as a solvent or diluent using little or no inert solvent as a solvent or diluent. A small fraction of inert solvent/diluent might be used as a carrier for catalyst and scavenger. A bulk polymerization system contains less than 25 wt % of inert solvent or diluent, such as less than 10 wt %, such as less than 1 wt %, such as 0 wt %.

The terms “catalyst compound”, “catalyst complex”, “transition metal complex”, “transition metal compound”, “precatalyst compound”, and “precatalyst complex” are used interchangeably.

A “catalyst system” is a combination of at least one catalyst compound, at least one activator, an optional coactivator, and an optional support material. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The catalyst compound may be neutral as in a precatalyst, or a charged species with a counter ion as in an activated catalyst system. For the purposes of the present disclosure and the claims thereto, when catalyst systems are described as including neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein are intended to embrace both neutral and ionic forms of the catalyst compounds and activators.

A catalyst system that utilizes a single catalyst compound means a catalyst system that is prepared using only a single catalyst compound in the preparation of the catalyst system. Thus, such a catalyst system is distinguished from, for example, “dual” catalyst systems, which are prepared using two catalyst compounds having different structural formulas, e.g., the connectivity between the atoms, the number of atoms, and/or the type of atoms in the two catalyst compounds is different. Thus, one catalyst compound is considered different from another if it differs by at least one atom, either by number, type, or connection. For example, bisindenyl zirconium dichloride is different from (indenyl)(2-methylindenyl) zirconium dichloride which is different from (indenyl)(2-methylindenyl) hafnium dichloride. Catalyst compounds that differ only in that they are stereoisomers of each other are not considered to be different catalyst compounds. For example, rac-dimethylsilylbis(2-methyl 4-phenyl)hafnium dimethyl and meso-dimethylsilylbis(2-methyl 4-phenyl)hafnium dimethyl are considered to be not different.

As used herein, and unless otherwise specified, the term “Cₙ” means hydrocarbon(s) having n carbon atom(s) per molecule, wherein n is a positive integer. Likewise, a “Cₘ-C_{y}” group or compound refers to a group or compound including carbon atoms at a total number thereof from m to y. Thus, a C₁-C₅₀ alkyl group refers to an alkyl group including carbon atoms at a total number thereof of about 1 to about 50.

The terms “cocatalyst” and “activator” are used herein interchangeably and are defined to be any compound which can activate any one of the catalyst compounds described above by converting the neutral catalyst compound to a catalytically active catalyst compound cation.

The term “continuous” means a system that operates without interruption or cessation for an extended period of time. For example, a continuous process to produce a polymer would be one where the reactants are continually introduced into one or more reactors and polymer product is continually withdrawn.

As used herein, the term “film” refers to a continuous, flat (in some instances, flexible) polymeric structure having an average thickness of a range of 0.1, or 1, or 5, or 10, or 15, or 20 μm to 50, or 75, or 100, or 150, or 200, or 250, or 1000, or 2000 μm, or such a coating of similar thickness adhered to a flexible, non-flexible or otherwise solid structure. The “film” may be made from or contain a single layer or multiple layers. Each layer may be made from or contain the polyethylene copolymers of the present disclosure. For example, one or more layers of a “film” may include a mixture of the disclosed polyethylene copolymer as well as a LDPE, another LLDPE, polypropylene, or a plastomer.

As used herein, a composition or film “free of” a component refers to a composition/film substantially devoid of the component or comprising the component in an amount of less than about 0.01 wt %, by weight of the total composition.

A “heterocyclic ring” is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

As used herein, and unless otherwise specified, the term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated or unsaturated), including mixtures of hydrocarbon compounds having different values of n.

The terms “hydrocarbyl radical,” “hydrocarbyl group,” or “hydrocarbyl” may be used interchangeably and are defined to mean a group including hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and aryl groups, such as phenyl, benzyl, naphthyl.

As used herein, Mn is number average molecular weight, Mw is weight average molecular weight, and Mz is z average molecular weight, wt % is weight percent, and mol % is mole percent. Molecular weight distribution (MWD), also referred to as polydispersity (PDI), is defined to be Mw divided by Mn. Unless otherwise noted, all molecular weight units (e.g., Mw, Mn, or Mz) are g/mol.

As used herein, an “olefin,” alternatively referred to as “alkene,” is a linear, branched, or cyclic compound of carbon and hydrogen having at least one double bond. For purposes of this specification and the claims appended thereto, when a polymer or copolymer is referred to as “comprising” an olefin, the olefin present in such polymer or copolymer is the polymerized form of the olefin. For example, when a copolymer is described as having an “ethylene” content of 35 wt % to 55 wt %, it is understood that the mer unit in the copolymer is derived from ethylene in the polymerization reaction and the derived units are present at 35 wt % to 55 wt %, based upon the weight of the copolymer.

As used herein, “olefin polymerization catalyst(s)” refer to any catalyst, such as an organometallic complex or compound that is capable of coordination polymerization addition where successive monomers are added in a monomer chain at the organometallic active center.

“Noncoordinating anion (NCA)” means an anion either that does not coordinate to the catalyst metal cation or that does coordinate to the metal cation, but only weakly. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. An NCA coordinates weakly enough that a neutral Lewis base, such as an olefinically or acetylenically unsaturated monomer can displace it from the catalyst center. Any metal or metalloid that can form a compatible, weakly coordinating complex may be used or contained in the noncoordinating anion. Suitable metals include, but are not limited to, aluminum, gold, and platinum. Suitable metalloids include, but are not limited to, boron, aluminum, phosphorus, and silicon. The term non-coordinating anion activator includes neutral activators, ionic activators, and Lewis acid activators. The terms “non-coordinating anion activator” and “ionizing activator” are used interchangeably herein.

As used herein, the term “polycyclic arenyl ligand” is used herein to mean a substituted or unsubstituted monoanionic C₉ to ClO₃ hydrocarbyl ligand that contains an aromatic five-membered hydrocarbyl ring (also referred to as a cyclopentadienyl ring) that is fused to one or two partially unsaturated, or aromatic hydrocarbyl ring structures which may be fused to additional saturated, partially unsaturated, or aromatic hydrocarbyl rings.

As used herein, the terms “polyethylene polymer,” “polyethylene copolymer,” “polyethylene,” “ethylene polymer,” “ethylene copolymer,” and “ethylene based polymer” mean a polymer or copolymer comprising at least 50 mol % ethylene units, or at least 70 mol % ethylene units, or at least 80 mol % ethylene units, or at least 90 mol % ethylene units, or at least 95 mol % ethylene units or 100 mol % ethylene units (in the case of a homopolymer).

As used herein, a “polymer” may refer to homopolymers, copolymers, interpolymers, terpolymers, etc. A “polymer” has two or more of the same or different monomer units. A “homopolymer” is a polymer having monomer units that are the same. A “copolymer” is a polymer having two or more monomer units that are different from each other. A “terpolymer” is a polymer having three monomer units that are different from each other. The term “different” as used to refer to monomer units indicates that the monomer units differ from each other by at least one atom or are different isomerically. Accordingly, the definition of copolymer, as used herein, includes terpolymers and the like. Likewise, the definition of polymer, as used herein, includes copolymers and the like.

As used herein, an ethylene polymer having a density of more than 0.860 to less than 0.910 g/cm³ is referred to as an ethylene plastomer or plastomer; an ethylene polymer having a density of 0.910 to 0.925 g/cm³is referred to as a “linear low density polyethylene” (LLDPE) when substantially linear (having minor or no long chain branching) as is typically the case for Ziegler-Nata or metallocene-catalyzed PE or branched low density polyethylene (LDPE) when significantly branched (having a high degree of long chain branching), as is often the case with free-radical polymerized PE; 0.925 to 0.940 g/cm³ is referred to as a “medium density polyethylene” (MDPE); and an ethylene polymer having a density of more than 0.940 g/cm³ is referred to as a “high density polyethylene” (HDPE). Density is determined according to ASTM D792. Specimens are prepared according to ASTM D4703—Annex 1 Procedure C followed by conditioning according to ASTM D618—Procedure A prior to testing.

As used herein, the term “polymerization conditions” refers to conditions conducive to the reaction of one or more olefin monomers when contacted with an activated olefin polymerization catalyst to produce a polyolefin polymer, including a skilled artisan's selection of temperature, pressure, reactant concentrations, optional solvent/diluents, reactant mixing/addition parameters, and other conditions within at least one polymerization reactor.

The terms “process” and “method” are used interchangeably.

The term “ring atom” means an atom that is part of a cyclic ring structure. By this definition, a benzyl group has six ring atoms and tetrahydrofuran has five ring atoms.

A “scavenger” is a compound that can be added to facilitate polymerization by scavenging impurities. Some scavengers may also act as activators and may be referred to as coactivators. A coactivator, that is not a scavenger, may also be used in conjunction with an activator in order to form an active catalyst. In at least one embodiment, a coactivator can be pre-mixed with the transition metal compound to form an alkylated transition metal compound.

The term “single catalyst compound” refers to a catalyst compound corresponding to a single structural formula, although such a catalyst compound may comprise and be used as a mixture of isomers, e.g., stereoisomers.

A “solution polymerization” means a polymerization process in which the polymer is dissolved in a liquid polymerization medium, such as an inert diluent or monomer(s) or their blends. A solution polymerization can be homogeneous. A homogeneous polymerization is one where the polymer product is dissolved in the polymerization medium. Suitable systems may be not turbid as described in J. Vladimir Oliveira, C. Dariva and J. C. Pinto, Ind. Eng. Chem. Res., 2000, Vol. 29, p. 4627.

The terms “substituent,” “radical,” “group,” and “moiety” may be used interchangeably.

Unless otherwise indicated, (e.g., the definition of “substituted hydrocarbyl”, “substituted aromatic”, etc.), the term “substituted” means that atleast one hydrogen atom has been replaced with at least one non-hydrogen group, such as a hydrocarbyl group, a heteroatom, or a heteroatom containing group, such as halide (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted aromatic,” means an aromatic group having 1 or more hydrogen groups replaced by a hydrocarbyl, substituted hydrocarbyl, heteroatom or heteroatom containing group.

The term “substituted hydrocarbyl” means a hydrocarbyl radical in which at least one hydrogen atom of the hydrocarbyl radical has been substituted with at least one heteroatom (such as halide, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted phenyl,” mean a phenyl group having 1 or more hydrogen groups replaced by a hydrocarbyl, substituted hydrocarbyl, heteroatom or heteroatom containing group.

Where isomers of a named alkyl, alkenyl, alkoxide, or aryl group exist (e.g., n-butyl, iso-butyl, sec-butyl, and tert-butyl), reference to an alkyl, alkenyl, alkoxide, or aryl group without specifying a particular isomer (e.g., butyl) expressly discloses all isomers (e.g., n-butyl, iso-butyl, sec-butyl, and tert-butyl).

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, “in a range” or “within a range” includes every point or individual value between its end points even though not explicitly recited and includes the end points themselves. Thus, every point or individual value may serve as its own lower or upper limit combined with any other point or individual value or any other lower or upper limit, to recite a range not explicitly recited.

### DETAILED DESCRIPTION

Various embodiments, versions of the disclosed compounds, processes, and articles of manufacture, will now be described, including specific embodiments and definitions that are adopted herein. While the following detailed description gives specific embodiments, those skilled in the art should appreciate that these embodiments are exemplary only, and that embodiments of the present disclosure can be practiced in other ways. Any reference to embodiments may refer to one or more, but not necessarily all, of the compounds, processes, or articles of manufacture defined by the claims. The use of headings is for purposes of convenience only and does not limit the scope of the present disclosure.

This disclosure relates to catalysts, catalyst systems, polyethylene polymers, polymerization processes for making such polyethylene polymers, and films made therefrom. Catalyst systems and processes described herein, employ a catalyst system of a metallocene catalyst for the polymerization of a long chain-branched polyethylene polymer with a combination of broad polydispersity index, broad orthogonal composition distribution, and a high composition distribution breadth index. In some embodiments, polyethylene polymers are copolymers having a combination of low density, low melt index, high melt index ratio, and long chain branching. Additionally, polyethylene polymers have commercially desirable polymerizations and extrusions of the polyethylene copolymers.

As compared to conventional LDPEs, polyethylene copolymers of the present disclosure have increased long chain branching (also referred to as “LCB”) and increased broad orthogonal composition distribution (BOCD) in the copolymers but still provide neck-in and draw stability. Polyethylene copolymers of the present disclosure can exhibit lower zero shear viscosity, leading to lower motor torque and lower melt pressures and melt temperatures during extrusion as compared to LLDPEs, providing increased output of the extruded polyethylene copolymer product. The LCB can be evidenced through, e.g., a high melt index ratio and/or rheology characteristics as shown by small angle oscillatory shear (SAOS) experiments (for instance, ratio of η_{0.01}/η₁₀₀, the complex viscosity recorded at shear rates of 0.01 and 100 rad/s, respectively).

In addition, it has been discovered that polyethylene copolymers of the present disclosure can provide excellent tear properties, dart impact strength, and stronger shear thinning than comparative PE's from both gas phase and high pressure process overcoming key weaknesses of LDPEs. For example, polyethylene copolymers of the present disclosure can provide films formed with reduced motor load and melt pressure (which increases throughput) due to improved flow behavior, as compared to conventional LLDPEs. For example, a reduction in melt pressure and decrease in melt temperature may be provided during film fabrication.

In at least one embodiment, the properties and performance of the polyethylene may be advanced by the combination of: (1) varying reactor conditions such as reactor temperature, reactor pressure, hydrogen concentration, comonomer concentration, and so on; and (2) selecting and feeding a catalyst system having a catalyst of the present disclosure.

The embodiments may advantageously hold a broad range of MI's with the same catalyst system. For a catalyst system fed to the polymerization reactor, the polymer MI, MIR, and density may be controlled by varying reactor conditions such as the reactor mixture including an additional catalyst added, operating temperature, operating pressure, hydrogen concentration, and comonomer concentration in the reaction mixture.

Evidence of the incorporation of comonomer into a polymer is indicated by the density of a polyethylene copolymer, with lower densities indicating higher incorporation. The difference in densities of the low molecular weight (LMW) component and the high molecular weight (HMW) component can be greater than about 0.02 g/cm³, or greater than about 0.04 g/cm³, with the HMW component having a lower density than the LMW component. Satisfactory control of the MWD and long-chain branching distribution (LCBD) lead to the adjustment of these factors, which can be adjusted by tuning the reactor conditions.

Other embodiments provide for a method of producing polyethylene, including introducing a composition comprising a contact product of a first diluent, a first catalyst compound, a support material, and an activator into a gas-phase fluidized bed reactor; exposing the first composition to polymerization conditions by polymerizing ethylene and at least one C₃-C₂₀ alpha-olefin by introducing the ethylene and the at least one C₃-C₂₀ alpha-olefin into the gas-phase fluidized bed reactor; and obtaining the polyethylene copolymer.

### Catalyst Compounds

In some embodiments, a catalyst is represented by Formula (I):

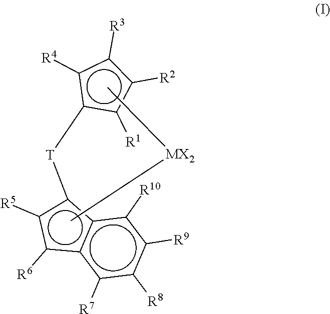

wherein:
M is a group 4 metal, such as titanium (Ti), zirconium (Zr), or hafnium (Hf);
each of R¹, R², R³, R⁴, R⁵, R⁶, R⁷, R⁸, R⁹, and R¹⁰ is independently hydrogen, substituted or unsubstituted hydrocarbyl, a substituted or unsubstituted heteroatom, or a substituted or unsubstituted heteroatom-containing group, or one or more of R⁵ and R⁶, R⁷ and R⁸, R⁸ and R⁹, and R⁹ and R¹⁰ are joined to form a substituted or unsubstituted completely saturated ring or a substituted or unsubstituted aromatic ring;
is T represents the formula R^{a}₂J, (R^{a})₄J₂, or (R^{a})₆J₃ wherein each J is independently C, Si, or Ge, and each R^{a} is independently hydrogen, halide, a substituted or unsubstituted C₁ to C₄₀ hydrocarbyl, wherein two R^{a} optionally can form a substituted or unsubstituted cyclic structure including a substituted or unsubstituted completely saturated ring, a substituted or unsubstituted partially saturated ring, or a substituted or unsubstituted aromatic ring (preferably, such ring structure includes J in the ring, and has from 2-10 carbon atoms in addition to the atom represented by J in the ring structure); and
each X is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene.

More particularly, each of R⁷, R⁸, R⁹, and R¹⁰ of Formula (I) can independently be hydrogen or C₁-C₁₀ alkyl (such as methyl, ethyl, propyl, butyl, pentyl, hexyl, heptyl, octyl, nonyl, or decyl), and preferably at least one of (1) R⁷ and R⁸, (2) R⁸ and R⁹, or (3) R⁹ and R¹⁰ are joined to form a substituted or unsubstituted ring (which may be either aromatic or completely saturated) fused to the indenyl ring shown in Formula (I). In particular, this could be a C₄, C₅, C₆, or C₇ aromatic ring (e.g., cyclopentadienyl, benzyl, etc.) or completely saturated ring (e.g., cyclopentyl, cyclobenzyl, etc.).

Each of R¹, R², R³, and R⁴ of Formula (I) can independently be hydrogen or C₁-C₁₀ alkyl (such as methyl, ethyl, propyl, butyl, pentyl, hexyl, heptyl, octyl, nonyl, or decyl), preferably methyl, ethyl, or propyl; most preferably each of R¹, R², R³, and R⁴ is methyl.

With respect to bridging group T, each R^{a} independently can most preferably be hydrogen or C₁ to C₂₀ hydrocarbyl, and J is preferably Si or C, most preferably Si. For example, T can be selected from CH₂, CH₂CH₂, C(CH₃) 2, CPh₂, SiMe₂, SiEt₂, SiPh₂, SiMePh, SiEtPh, SiMeEt, Si(CH₂)₃, Si(CH₂)₄, or Si(CH₂)₅, and preferably, T is SiMe₂, SiEt₂, or SiMeEt.

One or more of R¹, R², R³, R⁴, R⁵, R⁶, R⁷, R⁸, R⁹, and R¹⁰ of Formula (I) can independently be hydrogen, hydrocarbyl, silylcarbyl, alkoxyl, halide, or siloxyl.

In some embodiments of Formula (I), M is a group 4 metal, such as titanium (Ti), zirconium (Zr), or hafnium (Hf). In some embodiments, each X is independently a halide, such as chloro. In yet other embodiments, each X is independently a C₁-C₄ alkyl, such as methyl. In some embodiments, each X is independently selected from substituted or unsubstituted hydrocarbyl, a heteroatom or substituted or unsubstituted heteroatom-containing group, such as methyl, benzyl, trimethylsilyl, methyl(trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido.

In some embodiments of Formula (I), (1) M is Zr or Hf, (2) X is chloro or methyl, (3) T is Si(CH₂)₃, Si(CH₂)₄, or Si(CH₂)₅, (4) R⁵, R⁶, R⁷, R⁸, R⁹, and R¹⁰ is independently hydrogen or substituted or unsubstituted C₁-C₁₀ alkyl, (5) at least one of R⁷ and R⁸, R⁸ and R⁹, or R⁹ and R¹⁰ are joined to form a substituted or unsubstituted ring (saturated or aromatic, preferably a C₅ or C₆ saturated or aromatic ring) fused to the indenyl ring shown in Formula (I), and (6) R¹, R², R³, and R⁴ is independently hydrogen or C₁ to C₁₀ alkyl (preferably methyl, ethyl, or propyl). Preferably, R⁵ and R⁶ are hydrogen, and furthermore, whichever of R⁷-R¹⁰ are not joined to form the substituted or unsubstituted ring are also hydrogen (thus, where R⁷ and R⁸ are joined to form the ring, R⁹ and R¹⁰ are each hydrogen; and when R⁸ and R⁹ are joined to form the ring, R⁷ and R¹⁰ are each hydrogen). In some embodiments, the ring is an unsubstituted cyclopentyl ring fused to the indenyl ring of Formula (I). In yet other embodiments, the ring can be an unsubstituted benzyl ring fused to the indenyl ring of Formula (I). Where the ring is cyclopentyl, it is preferably formed from R⁸ and R⁹; where the ring is benzyl, it is preferably formed from R⁷ and R⁸.

Thus, the catalyst according to various embodiments could be either (I-a) or (I-b) below.

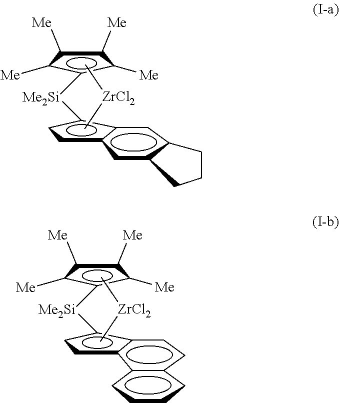

In some embodiments, the catalyst may include the fused benzyl ring as discussed above (e.g., in connection with Formula (I-b)), except the ring may be substituted. Thus, the catalyst in some embodiments is represented by Formula (II):

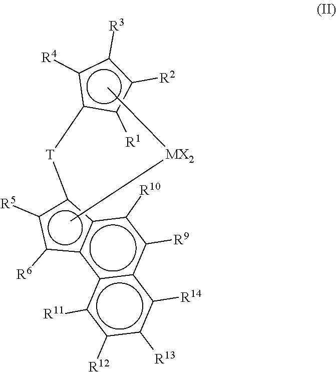

Wherein M, T, X, and R¹-R¹⁰ are in accordance with the discussion above respecting Formula (I), and each of R¹¹, R¹², R¹³, and R¹⁴ of Formula (II) is independently hydrogen or C₁-C₁₀ alkyl (such as methyl, ethyl, propyl, butyl, pentyl, hexyl, heptyl, octyl, nonyl, or decyl). Preferably, R¹-R⁴, T, and X are in accordance with the discussion above respecting Formula (I), and, more specifically, R⁵-R¹⁴ are each hydrogen.

### Polymerization Processes

A polymerization process can include a gas phase polymerization reaction, and in particular a fluidized bed gas phase polymerization reaction. Generally, in a fluidized gas bed process used for producing polymers, a gaseous stream containing one or more monomers is continuously cycled through a fluidized bed in the presence of a catalyst under reactive conditions. In some embodiments, the reaction medium includes condensing agents, which are typically non-coordinating inert liquids that are converted to gas in the polymerization processes, such as isopentane, isohexane, or isobutane. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are incorporated herein by reference.) The gas-phase polymerization may be carried out in any suitable reactor system, e.g., a stirred- or paddle-type reactor system. See U.S. Pat. Nos. 7,915,357; 8,129,484; 7,202,313; 6,833,417; 6,841,630; 6,989,344; 7,504,463; 7,563,851; and 8,101,691 for discussion of suitable gas phase fluidized bed polymerization systems, which are incorporated herein by reference.

In such polymerization processes, a gas-phase, fluidized-bed process is conducted by passing a stream containing ethylene and an olefin comonomer continuously through a fluidized-bed reactor under reaction conditions and in the presence of a catalyst composition at a velocity sufficient to maintain a bed of solid particles in a suspended state. A stream (which may be called a “cycle gas” stream) containing unreacted ethylene and olefin comonomer is continuously withdrawn from the reactor, compressed, cooled, optionally partially or fully condensed, and recycled back to the reactor. Prepared polyethylene copolymer is withdrawn from the reactor and replacement ethylene and olefin comonomer are added to the recycle stream. In some embodiments, gas inert to the catalyst composition and reactants is present in the gas stream.

The cycle gas can include induced condensing agents (ICA). An ICA is one or more non-reactive alkanes that are condensable in the polymerization process for removing the heat of reaction. In some embodiments, the non-reactive alkanes are selected from C₁-C₆ alkanes, e.g., one or more of propane, butane, isobutane, pentane, isopentane, hexane, as well as isomers thereof and derivatives thereof. In some instances, mixtures of two or more such ICAs may be particularly useful (e.g., propane and pentane, propane and butane, butane and pentane, etc.).

The reactor pressure during polymerization may be 100 psig (680 kPag)-500 psig (3448 kPag), such as 200 psig (1379 kPag)-400 psig (2759 kPag), such as 250 psig (1724 kPag)-350 psig (2414 kPag). In some embodiments, the reactor is operated at a temperature of 60° C. to 120° C., such as 60° C. to 115° C., such as 70° C. to 110° C., such as 70° C. to 95° C., such as 80° C. to 90° C. A ratio of hydrogen gas to ethylene can be 8 to 30 ppm/mol %, such as 8 to 15 ppm/mol %, such as 9 to 11 ppm/mol %.

The mole percent of ethylene (based on total monomers) may be 25-90 mole percent, such as 50-90 mole percent, or 60.0-75.0 mole percent, and the ethylene partial pressure (in the reactor) can be 75 psia (517 kPa)-300 psia (2069 kPa), or 100-275 psia (689-1894 kPa), or 150-265 psia (1034-1826 kPa), or 180-200 psia. Ethylene concentration in the reactor can also range from 35-95 mol %, such as within the range from a low of 35, 40, 45, 50, or 55 mol % to a high of 70, 75, 80, 85, 90, or 95 mol % and further where ethylene mol % is measured on the basis of total moles of gas in the reactor (including, if present, ethylene and/or comonomer gases as well as inert gases such as one or more of nitrogen, isopentane or other ICA(s), etc.); as with vol-ppm hydrogen, this measurement may for convenience be taken in the cycle gas outlet rather than in the reactor itself. Comonomer concentration can be 0.2-2 mol %, such as from a low of 0.2, 0.3, 0.4 or 0.5 mol % to a high of 0.65, 0.70, 0.75, 0.80, 0.85, 0.90, 0.95, 1.0, 1.5, or 2.0 mol %.

### Activators

The terms “cocatalyst” and “activator” are used herein interchangeably.

The catalyst systems described herein may include catalyst compound(s) as described above and an activator such as alumoxane or a non-coordinating anion and may be formed by combining the catalyst compounds described herein with activators in any manner known from the literature including combining them with supports, such as silica. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, may include alumoxanes, aluminum alkyls, ionizing activators, which may be neutral or ionic, and conventional-type cocatalysts. Suitable activators may include alumoxane compounds, modified alumoxane compounds, and ionizing anion precursor compounds that abstract a reactive, 6-bound, metal ligand making the metal compound cationic and providing a charge-balancing non-coordinating or weakly coordinating anion, e.g., a non-coordinating anion.

In some embodiments, the catalyst system includes an activator and a catalyst compound of Formula (I), Formula (II), Formula (III), and/or Formula (IV).

### Alumoxane Activators

Alumoxane activators are utilized as activators in the catalyst systems described herein. Alumoxanes are generally oligomeric compounds containing —Al(R^{a}′″)—O— sub-units, where R^{a}′″ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, such as when the abstractable ligand is an alkyl, halide, alkoxide or amide. Mixtures of different alumoxanes and modified alumoxanes may also be used. It may be suitable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584, which is incorporated by reference herein). Another useful alumoxane is solid polymethylaluminoxane as described in U.S. Pat. Nos. 9,340,630, 8,404,880, and 8,975,209, which are incorporated by reference herein.

When the activator is an alumoxane (modified or unmodified), and in at least one embodiment, an amount of activator at up to a 5,000-fold molar excess Al/M over the catalyst compound (per metal catalytic site) may be used. The minimum activator-to-catalyst-compound may be a 1:1 molar ratio. Alternate ranges may include about 1:1 to about 500:1, alternately about 1:1 to about 200:1, alternately about 1:1 to about 100:1, or alternately about 1:1 to about 50:1.

In an alternate embodiment, little or no alumoxane is used in the polymerization processes described herein. For example, alumoxane can be present at zero mol %, alternately the alumoxane can be present at a molar ratio of aluminum to catalyst compound transition metal less than 500:1, such as less than 300:1, such as less than 100:1, such as less than 1:1.

### Ionizing/Non-Coordinating Anion Activators

The term “non-coordinating anion” (NCA) means an anion which either does not coordinate to a cation or which is only weakly coordinated to a cation thereby remaining sufficiently labile to be displaced by a Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization. Suitable ionizing activators may include an NCA, such as a compatible NCA.

It is within the scope of the present disclosure to use an ionizing activator, neutral or ionic. It is also within the scope of the present disclosure to use neutral or ionic activators alone or in combination with alumoxane or modified alumoxane activators.

For descriptions of some suitable activators and activator combinations, as well as relative amounts of activators and catalyst compounds, and optional chain transfer agents for use in conjunction with these catalyst compounds, please see U.S. Pat. Nos. 8,658,556 and 6,211,105, incorporated by reference herein; as well as U.S. Patent Publication 2021/0179650, and in particular Paragraphs [0084]-[0135] of WIPO Patent Publication No. WO2021/257264, which description is incorporated by reference herein (including the various descriptions that are incorporated by reference therein, such as WO2004/026921 page 72, paragraph [00119] to page 81, paragraph [00151] and WO2004/046214 page 72, paragraph [00177] to page 74, paragraph [00178]).

Furthermore, a catalyst system of the present disclosure may include a metal hydrocarbenyl chain transfer agent represented by the formula:

Al(R′)₃₋ᵥ(R″)ᵥ

where each R′ can be independently a C₁-C₃₀ hydrocarbyl group, and or each R″, can be independently a C₄-C₂₀ hydrocarbenyl group having an end-vinyl group; and v can be from 0.1 to 3.

### Support Materials

In embodiments herein, the catalyst system may include an inert support material. The support material can be a porous support material, for example, talc, and inorganic oxides. Other support materials include zeolites, clays, organoclays, or another organic or inorganic support material, or mixtures thereof.

The support material can be an inorganic oxide. The inorganic oxide can be in a finely divided form. Suitable inorganic oxide materials for use in catalyst systems herein may include groups 2, 4, 13, and 14 metal oxides, such as silica, alumina, and mixtures thereof. Other inorganic oxides that may be employed either alone or in combination with the silica, or alumina can be magnesia, titania, zirconia. Other suitable support materials, however, can be employed, for example, finely divided functionalized polyolefins, such as finely divided polyethylene. Examples of suitable supports may include magnesia, titania, zirconia, montmorillonite, phyllosilicate, zeolites, talc, clays. Also, combinations of these support materials may be used, for example, silica-chromium, silica-alumina, silica-titania. In at least one embodiment, the support material is selected from Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area of about 10 m²/g to about 700 m²/g, pore volume of about 0.1 cm³/g to about 4.0 cm³/g and average particle size of about 5 m to about 500 m. The surface area of the support material can be of about 50 m²/g to about 500 m²/g, pore volume of about 0.5 cm³/g to about 3.5 cm³/g and average particle size of about 10 m to about 200 m. For example, the surface area of the support material can be about 100 m²/g to about 400 m²/g, pore volume of about 0.8 cm³/g to about 3.0 cm³/g and average particle size can be about 5 m to about 100 m. The average pore size of the support material useful in the present disclosure can be of about 10 Å to about 1000 Å, such as about 50 Å to about 500 Å, and such as about 75 Å to about 350 Å. In at least one embodiment, the support material is a high surface area, amorphous silica (surface area=300 m²/gm; pore volume of 1.65 cm³/gm). For example, suitable silicas can be the silicas marketed under the tradenames of DAVISON™ 952 or DAVISON™ 955 by the Davison Chemical Division of W.R. Grace and Company. In other embodiments, DAVISON™ 948 is used. Alternatively, a silica can be ES-70™ silica (PQ Corporation, Malvern, Pennsylvania) that has been calcined, for example (such as at 875° C.).

The support material should be dry, that is, free or substantially free of absorbed water. Drying of the support material can be effected by heating or calcining at about 100° C. to about 1000° C., such as at least about 600° C. When the support material is silica, it is heated to at least 200° C., such as about 200° C. to about 850° C., and such as at about 600° C.; and for a time of about 1 minute to about 100 hours, about 12 hours to about 72 hours, or about 24 hours to about 60 hours. The calcined support material must have at least some reactive hydroxyl (OH) groups to produce supported catalyst systems of the present disclosure. The calcined support material is then contacted with at least one polymerization catalyst including at least one catalyst compound and an activator.

The support material, having reactive surface groups, such as hydroxyl groups, is slurried in a non-polar diluent and the resulting slurry is contacted with a solution of a catalyst compound and an activator. In at least one embodiment, the slurry of the support material is first contacted with the activator for a period of time of about 0.5 h to about 24 h, about 2 h to about 16 h, or about 4 h to about 8 h. The solution of the catalyst compound is then contacted with the isolated support/activator. In at least one embodiment, the supported catalyst system is generated in situ. In alternate embodiments, the slurry of the support material is first contacted with the catalyst compound for a period of time of about 0.5 h to about 24 h, about 2 h to about 16 h, or about 4 h to about 8 h. The slurry of the supported catalyst compound is then contacted with the activator solution.

The mixture of the catalyst(s), activator(s) and support is heated about 0° C. to about 70° C., such as about 23° C. to about 60° C., such as at room temperature. Contact times can be about 0.5 hours to about 24 hours, such as about 2 hours to about 16 hours, or about 4 hours to about 8 hours.

Suitable non-polar diluents are materials in which all of the reactants used herein, e.g., the activator and the catalyst compound, are at least partially soluble and which are liquid or gas at reaction temperatures. Non-polar diluents can be alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

In at least one embodiment, the support material is a supported methylalumoxane (SMAO), which is an MAO activator treated with silica (e.g., ES-70-875 silica).

### Polyethylene Copolymers

The present disclosure provides polyethylene copolymers having a combination of low density, high melt index, long chain branching, broad orthogonal compositional distribution, and bimodal composition distribution. In addition, the polyethylene copolymers and films thereof can be formed by commercially desirable polymerizations and extrusions of the polyethylene copolymers.

Thus, polyethylene copolymers of various embodiments herein can exhibit one or more of the following properties:
Density within the range from 0.914 to 0.926 g/cm³, such as from a low of any one of 0.914, 0.915, 0.916, 0.917, 0.918, 0.919, or 0.92 g/cm³ to a high of any one of 0.926, 0.925, 0.924, 0.923, 0.922, 0.921, 0.920, or 0.919 g/cm³, such as 0.915 g/cm³ to 0.920 g/cm³, alternatively 0.918 g/cm³ to 0.922 g/cm³, with combinations from any low to any high contemplated (provided the high end is greater than the low end), e.g., 0.916 to 0.921 g/cm³.
Melt Index (MI, also referred to as I₂ or I_{2.16} in recognition of the 2.16 kg loading used in the test) of about 0.1 or greater g/10 min (ASTM D1238, 190° C., 2.16 kg), such as from a low of any one of 0.1, 0.2, 0.3, 0.4, 0.5, 0.6, 0.7, 0.8, 0.9, 1, 1.1, 1.2, 1.3, 1.4, or 1.5 g/10 min to a high end of any one of 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 4, 5, or 6 g/10 min, with ranges from any low end to any high end contemplated herein (provided the high end is greater than the low end), such as about 0.1 to about 1.2 g/10 min, alternatively about 1.4 to about 2.5 g/10 min, alternatively about 4 to about 5.9 g/10 min, etc.

The polyethylene copolymer may be the polymerization product of an ethylene monomer and one or more olefin comonomers, such as alpha-olefin comonomers. Alpha-olefin comonomers can have 3 to 12 carbon atoms, or from 4 to 10 carbon atoms, or from 4 to 8 carbon atoms. Olefin comonomers can be selected from the group consisting of propylene, 1-butene, 1-pentene, 1-hexene, 1-heptene, 1-octene, 4-methylpent-1-ene, 1-nonene, 1-decene, 1-undecene, 1-dodecene, 1-hexadecene, and the like, and any combination thereof, such as 1-butene, 1-hexene, and/or 1-octene. In some embodiments, a polyene is used as a comonomer. In some embodiments, the polyene is selected from the group consisting of 1,3-hexadiene, 1,4-hexadiene, cyclopentadiene, dicyclopentadiene, 4-vinylcyclohex-1-ene, methyloctadiene, 1-methyl-1,6-octadiene, 7-methyl-1,6-octadiene, 1,5-cyclooctadiene, norbornadiene, ethylidene norbornene, 5-vinylidene-2-norbornene, 5-vinyl-2-norbornene, and olefins formed in situ in the polymerization medium. In some embodiments, comonomers are selected from the group consisting of isoprene, styrene, butadiene, isobutylene, chloroprene, acrylonitrile, and cyclic olefins. In some embodiments, combinations of the olefin comonomers are utilized. In some embodiments, the olefin comonomer is selected from the group consisting of 1-butene and 1-hexene. The olefin comonomer content of the polyethylene copolymer can range from a low of about 0.1, 5, 5.5, 6, 6.5, 7, 7.5, 8, or 8.5 wt % to a high of about 20, 15, 13, 12.5, 12, 11.5, 11, 10.5, 10, 9.5, or 9 wt %, on the basis of total weight of monomers in the polyethylene copolymer. The balance of the polyethylene comonomer is made up of units derived from ethylene (e.g., from a low of 80, 85, 88, 90, 91, 92, 92.5, 93, 93.5, or 94 wt % to a high of 90, 91, 92, 92.5, 93, 93.5, 94, 94.5, 95, 95.5, 96, 97, 99, or 99.9 wt %). Ranges from any foregoing low end to any foregoing high end are contemplated herein (e.g., about 88 about to 93 wt %, such as about 91 to about 93 wt % ethylene-derived units and the balance olefin comonomer-derived content).

The polyethylene copolymers can also have a high load melt index (HLMI) (also referred to as I₂₁ or I_{21.6} in recognition of the 21.6 kg loading used in the test) within the range from a low of about 30, 35, 40, 45, 50, or 55 g/10 min to a high of about 275, 270, 260. 250, 240, 230, 220, 210, 200, 190, 180, 170, 160, 150, 140, 130, 120, 110, 100, 90, 80, 70, or g/10 min; with ranges from any of the foregoing lows to any of the foregoing highs contemplated herein (e.g., about 90 to about 275 g/10 min, such as about 110 to about 140 g/10 min, alternatively about 270 to about 275 g/10 min). The term “high load melt index” (“HLMI”), is the number of grams extruded in 10 minutes under the action of a standard load (21.6 kg) and is an inverse measure of viscosity. As provided herein, HLMI (I₂₁) is determined according to ASTM D1238 (190° C./21.6 kg) and is also sometimes referred to as I₂₁ or I_{21.6}.

The polyethylene copolymers can also have a melt index ratio (MIR, defined as the ratio of I_{21.6}/I_{2.16}) within the range from a low of any one of about 20, 25, 30, 35, 40, 45, 50, or 55 to a high of any one of about 150, 140, 130, 120, 110, 100, 90, 80, 70, 60, 50, or 40 with ranges from any of the foregoing lows to any of the foregoing highs contemplated herein (e.g., about 40 to about 70, alternatively about 140 to about 150).

The polyethylene copolymers can also have a molecular weight distribution (MWD) of about 2 to about 15, such as about 9 to about 13. The MWD can also range from a low of about 2, 2.5, 3, 3.5, 4, 4.2, 4.4, 4.6, 4.8, 5, 5.1, 5.2, 5.3, 5.4, 5.5, or 6 to a high of about 3.5, 4, 4.5, 5, 5.1, 5.2, 5.3, 5.4, 5.5, 5.6, 5.7, 5.8, 5.9, 6, 6.5, 7, 7.5, 8, 8.5, 9, 9.5, 10, 10.5, 11, 11.5, or 12 with ranges from any foregoing low to any foregoing high contemplated, provided the high end of the range is greater than the low end. MWD is defined as the weight average molecular weight (Mw) divided by number-average molecular weight (Mn).

Weight-average molecular weight (Mw) of polyethylene copolymers of various embodiments may be within the range from about 70,000 to about 300,000 g/mol, such as about 75,000 to about 150,000 g/mol, such as about 90,000 to about 130,000 g/mol, alternatively about 200,000 to about 250,000 g/mol, with ranges from any foregoing low end to any foregoing high end contemplated.

Number-average molecular weight (Mn) of polyethylene copolymers of various embodiments may be within the range from about 10,000 to about 40,000 g/mol, such as about 10,000 to about 30,000 g/mol, such as about 12,000 to about 15,000 g/mol, alternatively about 10,000 to about 12,000 g/mol, with ranges from any foregoing low end to any foregoing high end contemplated.

Z-average molecular weight (Mz) of polyethylene copolymers of various embodiments may be within the range from about 400,000 to about 950,000 g/mol, such as about 400,000 to about 650,000 g/mol, or about 775,000 to about 930,000 g/mol, or about 400,000 to about 550,000 g/mol, with ranges from any foregoing low end to any foregoing high end contemplated.

Polyethylene copolymers of various embodiments may also exhibit long-chain branching. As noted previously, this may be evidenced through, e.g., SAOS viscosity data (especially η_{0.01}/η₁₀₀) and/or MIR. SAOS viscosity data of polyethylene copolymers of various embodiments may be within the range from 10-60, e.g., 10-20, 20-30, or 40-55 η_{0.01}/η₁₀₀. Further, LCB or branching index (referred to herein as g′ᵥᵢₛ or alternatively g′_{vis ave}) could be less than 1, such as within the range from about 0.6 to about 0.99, about 0.7 to about 0.8, such as about 0.71 to about 0.73, alternatively about 0.6 to about 0.7, with ranges from any foregoing low end to any foregoing high end contemplated. In addition, polyethylene copolymers (even LLDPE) with some LCB will exhibit an inflection point in their Van Gurp Palmen curve, while LLDPE without any LCB present show no such inflection point.

Polyethylene copolymers of various embodiments may also exhibit lower phase angles at 10 kPA. Phase angle data measures the viscous and elastic properties of a material. Phase angle data of polyethylene copolymers of various embodiments may be within the range from about 40 to about 55 degrees at 10 kPa.

Polyethylene copolymers of various embodiments may also exhibit a higher shear thinning index (STI 0.1/100). STI 0.1/100 data measures the ratio of complex viscosities at 0.1 and 100 rad/s. STI 0.1/100 data of polyethylene copolymers of various embodiments may be within the range from about 10 to about 55 rad/s.

Rheological data such as “Complex shear viscosity (η*),” reported in Pascal seconds, can be measured at 0.01 rad/sec and 100 rad/sec. Complex shear viscosity and other rheological measurements can be obtained from small angle oscillatory shear (SAOS) experiments.

For instance, complex shear viscosity can be measured with a rotational rheometer such as an Advanced Rheometrics Expansion System (ARES-G2 model) or Discovery Hybrid Rheometer (DHR-3 Model) using parallel plates (diameter=25 mm) in a dynamic mode under nitrogen atmosphere. The rheometer can be thermally stable at 190° C. for at least 20 minutes before inserting compression-molded specimen onto the parallel plates. To determine the specimen's viscoelastic behavior, a frequency sweep in the range from 0.01 to 628 rad/s can be carried out at a temperature of 190° C. under constant strain that does not affect the measured viscoelastic properties. The sweep frequencies are equally spaced on a logarithmic scale, so that 5 frequencies are probed per decade. Depending on the molecular weight and temperature, strains of 3% can be used and linearity of the response is verified. A nitrogen stream is circulated through the oven to minimize chain extension or cross-linking during the experiments. The specimens can be compression molded at 190° C., without stabilizers. A sinusoidal shear strain can be applied. The shear thinning slope (STS) can be measured using plots of the logarithm (base ten) of the dynamic viscosity versus logarithm (base ten) of the frequency. The slope is the difference in the log(dynamic viscosity) at a frequency of 100 s⁻¹ and the log(dynamic viscosity) at a frequency of 0.01 s⁻¹ divided by 4. The complex shear viscosity (η*) versus frequency (ω) curves can be fitted using the Carreau-Yasuda model:

η*−η∞=(η₀−η∞)*(1+(λω)^{a})^{(n-1)/a}

The five parameters in this model are: η₀, the zero-shear viscosity; λ, the relaxation time; and n, the power-law index; η∞, the infinite rate viscosity; and a, the transition index. The zero-shear viscosity is the value at a plateau in the Newtonian region of the flow curve at a low frequency, where the dynamic viscosity is independent of frequency. The relaxation time corresponds to the inverse of the frequency at which shear-thinning starts. The power-law exponent describes the extent of shear-thinning, in that the magnitude of the slope of the flow curve at high frequencies approaches n−1 on a log(η*)−log(ω) plot. For Newtonian fluids, n=1 and the dynamic complex viscosity is independent of frequency.

In addition to dynamic and complex viscosity (each in Pascal seconds), at each frequency sweep in the SAOS experiment, various other parameters are collected, including storage modulus (Pa), Loss modulus (Pa), Complex Modulus (Pa), tan(delta), and phase angle. Charting the phase angle versus the complex shear modulus from the rheological experiment yields Van Gurp Palmen plots useful to extract some information on the molecular characteristics, for example, linear vs. long chain branched chains, type of long chain branching, polydispersity (Dealy, M. J., Larson, R. G., “Structure and Rheology of Molten Polymers”, Carl Hanser Verlag, Munich 182-183 (2006). It has been also suggested that Van Gurp Palmen plots can be used to reveal the presence of long chain branching in polymers. See Trinkle, S., Walter, P., Friedrich, C. “Van Gurp-Palmen plot II-Classification of long chain branched polymers by their topology”, in 41 Rheol. Acta 103-113 (2002).

“Shear thinning ratio”, which is reported as a unitless number, is characterized by the decrease of the complex viscosity with increasing shear rate. Herein, shear thinning can be determined as a ratio of complex viscosity at a frequency of 0.01 rad/s to the complex viscosity at a frequency of 100 rad/s.

The distributions and the moments of molecular weight (Mw, Mn, Mw/Mn, etc.), and the branching index (g′vis) are determined by using a high temperature Gel Permeation Chromatography (Polymer Char GPC-IR) equipped with a multiple-channel band-filter based Infrared detector IR5, an 18-angle Wyatt Dawn Heleos light scattering detector and a 4-capillary viscometer with Wheatstone bridge configuration. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 ml/min and the nominal injection volume is 200 μL. The whole system including transfer lines, columns, and viscometer detector are contained in ovens maintained at 145° C. The polymer sample is weighed and sealed in a standard vial with 80-μL flow marker (Heptane) added to it. After loading the vial in the autosampler, polymer is automatically dissolved in the instrument with 8 ml added TCB solvent. The polymer is dissolved at 160° C. with continuous shaking for about 2 hour. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10 million g/mol. The MW at each elution volume is calculated with the following equation:

$$log M = \frac{log ( {K}_{PS} / K )}{a + 1} + \frac{{a}_{PS} + 1}{a + 1} log {M}_{PS}$$

where the variables with subscript “PS” stand for polystyrene while those without a subscript are the test samples. In this method, α_{PS}=0.67 and K_{PS}=0.000175 while a and K are for ethylene-hexene copolymers as calculated from empirical equations (Sun, T. et al. Macromolecules 2001, 34, 6812), in which a=0.695 and K=0.000579(1-0.75 Wt), where Wt is the weight fraction for hexene comonomer. It should be noted that the comonomer composition is determined by the ratio of the IR5 detector intensity corresponding to CH₂ and CH₃ channel calibrated with a series of PE and ethylene-hexene homo/copolymer standards whose nominal values are predetermined by NMR or FTIR. Here the concentrations are expressed in g/cm³, molecular weight is expressed in g/mol, and intrinsic viscosity (hence K in the Mark-Houwink equation) is expressed in dL/g.

The LS molecular weight (M) at each point in the chromatogram is determined by analyzing the LS output using the Zimm model for static light scattering

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Ko is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm. For purposes of the present disclosure and the claims thereto (dn/dc)=0.1048 for ethylene-hexene copolymers. Unless stated otherwise, it should be assumed that MW values reported herein are determined using the LS methodology.

Viscosity-average molecular weight (M_{V}): A high temperature Polymer Char viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as M=K_{PS}M^{α}^{_{PS}}⁺¹/[η], where αps is 0.67 and Kps is 0.000175. The average intrinsic viscosity [η]avg of the sample is calculated by

$${[ η ]}_{avg} = \frac{\sum {{c}_{i} [ η ]}_{i}}{\sum {c}_{i}}$$

where the summations are over the chromatographic slices, i, between the integration limits.

The branching index (g′ᵥᵢₛ) can be calculated using the output of the GPC-IR5-LS-VIS method as follows. First, it is noted that g′ or g′ᵥᵢₛ can in general be considered the ratio of a polymer's intrinsic viscosity to that of a linear polymer of the same molecular weight and composition: g′=[η_{polymer}]/[η_{reference}], where [η_{polymer}] is the intrinsic viscosity of the polymer under investigation and [η_{reference}] is the intrinsic viscosity of a linear resin of the same composition with the same molecular weight. A polymer's relative intrinsic viscosity (g′) is therefore a measure of how much the polymer enhances its solution's viscosity relative to how much a linear polymer of the same molecular weight and composition enhances its solution's viscosity, under the same conditions of temperature and pressure.

Following this principle, the [η_{polymer}]value in the above simplified relationship may be taken as the weight-average intrinsic viscosity, [η]_{avg}, of the sample, which is calculated by:

$${[ η ]}_{avg} = \frac{\sum {{c}_{i} [ η ]}_{i}}{\sum {c}_{i}}$$

where the summations are over the chromatographic slices, i, between the integration limits. The branching index g′ᵥᵢₛ is defined against the linear reference as

$${g}_{vis}^{′} = \frac{{[ η ]}_{avg}}{{KM}_{v}^{α}} ,$$

where M_{V} is the viscosity-average molecular weight based on molecular weights determined by LS analysis and the K and α are for the reference linear polymer; for purposes of the present disclosure, α and K are the same as described above for linear polyethylene polymers.

The branching index g′ᵥᵢₛ may equivalently be referred to as g′_{vis ave} to reflect that it is an average value of g′ determined at each of multiple discrete concentration slices. For example, one can plot g′ as a function of molecular weight (or log of molecular weight, as is commonly done on GPC plots) for various polyethylene copolymers, implying a g′ value can be calculated for a given molecular weight population of polymer chains in the polyethylene copolymer composition. The above calculations provide the g′_{vis ave} as a weighted average of these multiple g′ values, and the g′_{vis ave} can be taken as a good relative indicator of the presence of long chain branching when comparing such value between two different copolymer compositions, with lower g′_{vis ave} indicating greater long chain branching.

### Composition Distribution

“BOCD” refers to a Broad Orthogonal Composition Distribution in which the comonomer of a copolymer is incorporated predominantly in the high molecular weight chains or species of a polyolefin polymer or composition. On the other hand, a more even comonomer or composition distribution is seen where polymer chains of varying length have similar amounts of comonomer (short-chain) incorporation. The distribution of the short chain branches can be measured, for example, using Temperature Raising Elution Fractionation (TREF) in connection with a Light Scattering (LS) detector to determine the weight average molecular weight of the molecules eluted from the TREF column at a given temperature. The combination of TREF and LS (TREF-LS) yields information about the breadth (or similarity, i.e., narrowness) of the composition distribution and whether the comonomer content increases, decreases, or is moderately or highly uniform across the chains of different molecular weights of polymer chains. BOCD and other composition distribution concepts have been described, for example, in U.S. Pat. Nos. 8,378,043, Col. 3, line 34, bridging Col. 4, line 19, and 8,476,392, line 43, bridging Col. 16, line 54.

The present polyethylene copolymers have comonomer distribution reflecting a similar degree of comonomer incorporation on polymer chains of varying length of the polyethylene copolymer, which is quantified in the CDBI. For instance, polyethylene copolymers can have a high composition distribution breadth index (CBDI), in which the polyethylene copolymers may have a CBDI % of about 50%, 55%, 60%, 65%, or 70% to about 75%, 80%, or 85%; with ranges from any of the foregoing lows to any of the foregoing highs contemplated herein (e.g., 50% to 80%, such as 70% to 75% or 80%). CDBI is defined as the weight percent of the copolymer molecules having a comonomer content within 50% of the median total molar comonomer content (i.e., within +/−25% of the median), and it is referenced, e.g., in U.S. Pat. No. 5,382,630. In general, copolymers with a broader distribution result in a lower CDBI, while a theoretical copolymer with exactly the same relative comonomer content across all different lengths of polymer chains would have a CDBI of 100%. The CDBI of a copolymer is readily determined utilizing a technique for isolating individual fractions of a sample of the copolymer. One such technique is generation of a solubility distribution curve using Temperature Rising Elution Fraction (TREF), as described in WO 1993003093 (which in turn references Wild, et al., J. Poly. Sci., Poly. Phys. Ed. , vol. 20, p. 441 (1982) and U.S. Pat. No. 5,008,204 in this regard). All three of the foregoing publications are incorporated herein by reference.

### Blends and Additives

In some embodiments, the polyethylene copolymers can be formulated (e.g., blended) with one or more other polymer components. In some embodiments, those other polymer components are alpha-olefin polymers such as polypropylene or polyethylene homopolymer and copolymer compositions. In some embodiments, those other polyethylene polymers are selected from the group consisting of linear low density polyethylene, high density polyethylene, medium density polyethylene, low density polyethylene, and other differentiated polyethylenes.

In some embodiments, the formulated blends can contain additives, which are determined based upon the end use of the formulated blend. In some embodiments, the additives are selected from the group consisting of fillers, antioxidants, phosphites, anti-cling additives, tackifiers, ultraviolet stabilizers, heat stabilizers, antiblocking agents, release agents, antistatic agents, pigments, colorants, dyes, waxes, silica, processing aids, neutralizers, lubricants, surfactants, and nucleating agents. In some embodiments, additives are present in an amount from 0.1 ppm to 5.0 wt %.

Polyethylene copolymers of the present disclosure can be optionally blended with one or more processing aids to form a polyethylene blend. Because of the improved properties of polyethylene copolymers of the present disclosure, advantageously, such processing aids can be omitted even in blown films (e.g., films, and particularly blown films, of some embodiments may be free of or substantially free of polymer processing aids, and especially polymer processing aids comprising fluorine; where “substantially free” means free of any intentionally added components, but allowing for up to 100 ppm of such component(s) as impurities).

### Articles of Manufacture

The polyethylene copolymers of the present disclosure can be particularly suitable for making end-use articles of manufacture such as films (e.g., as may be formed by lamination, extrusion, coextrusion, casting, and/or blowing); as well as other articles of manufacture as may be formed, e.g., by rotomolding or injection molding. Polyethylene copolymers can be formed into articles of manufacture by cast film extrusion, blown film extrusion, rotational molding or injection molding processes. In some embodiments, the polyethylene copolymer can be used in a blend.

In addition, it has been discovered that polyethylene copolymers of the present disclosure can provide stronger shear thinning and better extrusion processability than comparative PE's from both gas phase and high pressure process, overcoming key weaknesses of LDPEs and LLDPEs. For example, polyethylene copolymers of the present disclosure can provide films formed with reduced motor load and melt pressure (which increases throughput) due to improved flow behavior, as compared to conventional LLDPEs. For example, a reduction in melt pressure and decrease in melt temperature may be provided during film fabrication. Films of the present polyethylene copolymers formed in low pressure processes may provide better tear properties and Dart impact strength (as compared to LDPEs) as well as increased processability, much better drawdown characteristics, reducing the overall energy consumption cost (as compared to LLDPEs).

A polyethylene copolymer (or blend thereof) of the present disclosure can be useful in such forming operations as film, sheet, and fiber extrusion and co-extrusion as well as blow molding, injection molding, and rotary molding. Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, membranes, etc., in food-contact and non-food contact applications. For example, polyethylene copolymers of the present disclosure provide improved shrink wrap capability due to broad orthogonal composition distributions and long chain branching properties. Fibers include melt spinning, solution spinning and melt blown fiber operations for use in woven or non-woven form to make filters, diaper fabrics, medical garments, geotextiles, etc. Extruded articles include medical tubing, wire and cable coatings, pipe, geomembranes, and pond liners. Molded articles include single and multi-layered constructions in the form of bottles, tanks, large hollow articles, rigid food containers and toys, etc.

The polyethylene copolymers (or blends thereof) may be formed into monolayer or multilayer films. These films may be formed by any of the conventional techniques including extrusion, co-extrusion, extrusion coating, lamination, blowing and casting. The film may be obtained by the flat film or tubular process which may be followed by orientation in a uniaxial direction or in two mutually perpendicular directions in the plane of the film. One or more of the layers of the film may be oriented in the transverse and/or longitudinal directions to the same or different extents. This orientation may occur before or after the individual layers are brought together. For example a polyethylene copolymer (or blend thereof) layer can be extrusion coated or laminated onto an oriented polypropylene layer or the polyethylene copolymer (or blend thereof) and polypropylene can be coextruded together into a film then oriented. Likewise, oriented polypropylene could be laminated to oriented polyethylene copolymer (or blend thereof), or oriented polyethylene copolymer (or blend thereof) could be coated onto polypropylene then optionally the combination could be oriented even further.

Films include monolayer or multilayer films. Particular end use films include, for example, blown films, cast films, stretch films, stretch/cast films, stretch cling films, stretch handwrap films, machine stretch wrap, shrink films, shrink wrap films, greenhouse films, laminates, and laminate films. Exemplary films are prepared by any conventional technique known to those skilled in the art, such as for example, techniques utilized to prepare blown, extruded, and/or cast stretch and/or shrink films (including shrink-on-shrink applications).

In at least one embodiment, multilayer films (multiple-layer films) may be formed by any suitable method. The total thickness of multilayer films may vary based upon the application desired. A total film thickness of 5-100 μm, such as 10-50 μm, is suitable for most applications. Those skilled in the art will appreciate that the thickness of individual layers for multilayer films may be adjusted based on desired end-use performance, polymer(s) employed, equipment capability, and other factors. The materials forming each layer may be coextruded through a coextrusion feedblock and die assembly to yield a film with two or more layers adhered together but differing in composition. Coextrusion can be adapted for use in both cast film or blown film processes. Exemplary multilayer films have at least two, at least three, or at least four layers. In one embodiment the multilayer films are composed of five to ten layers.

In at least one embodiment, a film of the present disclosure has an averaged 1% Secant Modulus (M), at 23° C. according to a ASTM D882-18 of about 30,000 psi to about 40,000 psi, such as about 31,000 psi to about 40,000 psi, such as about 33,000 to about 38,000 psi, such as about 34,000 psi to about 36,000 psi.

A film of the present disclosure can have an Elmendorf Tear value, in accordance with ASTM D-1922. In at least one embodiment, a film has an Elmendorf Tear (MD) of at least 30 g/mil, such as at least 50 g/mil to about 200 g/mil, such as about 60 g/mil to about 100 g/mil, such as about 100 g/mil to about 180 g/mil. In at least another embodiment, a film has an Elmendorf Tear (TD) of at least 400 g/mil, such as at least 400 g/mil to about 500 g/mil, such as about 410 g/mil to about 460 g/mil, such as about 440 g/mil to about 470 g/mil.

A film of the present disclosure can have a Dart Drop Impact (or Impact Failure or Dart F50 or Dart Drop Impact Strength (DIS)), reported in grams (g) or grams per mil (g/mil), in accordance with ASTM D-1709, method A. A film of the present disclosure can have a Dart Drop Impact of from about 5 g/mil to about 600 g/mil. In at least one embodiment, the film has a Dart Drop Impact of at least about 100 g/mil, such as at least about 120 g/mil, such as at least about 130 g/mil. For example, the Dart Drop Impact can be about 100 g/mil to about 200 g/mil, such as about 120 g/mil to about 170 g/mil, such as about 130 g/mil to about 160 g/mil.

In certain embodiments, the film may have a puncture energy at break (also known as puncture break energy), in accordance with a modified BSI CEN 14477, of at least about 25 in-lbs/mil, such as at least about 30 in-lbs/mil, such as at least about 35 in-lbs/mil, such as about 25 in-lbs/mil to about 40 in-lbs/mil, such as about 30 in-lbs/mil to about 40 in-lbs/mil, such as about 30 in-lbs/mil to about 35 in-lbs/mil.

In at least one embodiment, a film of the present disclosure has a haze value of about 45% or less, about 40% or less, about 35% or less, about 30% or less, about 25% or less, about 20% or less, about 15% or less, or about 10% or less, as determined by ASTM D-1003.

In at least one embodiment, a film of the present disclosure has a clarity (defined as regular transmitted light that is deflected less than 0.1 from the axis of incident light through the bulk of the film sample) of about 80% or greater, about 85% or greater, about 90% or greater, about 95% or greater, about 97% or greater, as determined by ASTM D1746.

In at least one embodiment, a film of the present disclosure has a gloss of about 30% or greater, about 35% or greater, about 40% or greater, about 45% or greater, about 50% or greater, as determined by ASTM D-2457, where a light source is beamed onto the film surface at an angle of 45° and the amount of light reflected is measured.

### EXPERIMENTAL

### Synthesis:

General Considerations and Reagents: All manipulations were performed under an inert atmosphere using glove box techniques unless otherwise stated. Toluene and Pentane were purchased from Sigma Aldrich and were degassed and dried over 3 Å molecular sieves overnight prior to use.¹ Methylaluminoxane was purchased from Grace and used as received.

Synthesis of Catalyst 1:

### Synthesis of Lithium (Benz[e]indenide)

To a colorless solution of Benz[e]indene (11.40 g, 68.5 mmol, 1.00 equiv) in ether (100 mL) at −35° C. was added 2.74M butyllithium in hexanes (25.0 mL, 68.5 mmol, 1.00 equiv) to give an amber-yellow solution. The solution was stirred 30 minutes and then evaporated under vacuum, leaving light manila solid. The solid was washed with pentane (40 mL) and dried under vacuum. The yield was 11.72 g (99%) white powder. ¹H NMR (THF-d8) δ 8.05 (dm, 1H), 7.50 (dm, 1H), 7.46 (dd, 1H), 7.10 (m, 1H), 6.92 (m, 1H), 6.79 (d, 1H), 6.61 (m, 1H), 6.47 (t, 1H), 6.11 (m, 1H).

### Synthesis of Dimethyl(tetramethylcyclopentadienyl)silyl trifluoromethanesulfonate

To a pale amber solution of chlorodimethyl(tetramethylcyclopentadienyl)silane (30.00 g, 140 mmol, 1.00 equiv.) in toluene (100 mL) was added in portions silver trifluoromethanesulfonate (38.00 g, 148 mmol, 1.06 equiv) to give a cloudy gray-pink mixture. The reaction warmed and became gray-violet. The reaction was stirred 4 hours and then evaporated under vacuum, leaving a dark soupy mixture. The mixture was extracted with pentane (100 mL, then 3×20 mL) and the extracts filtered to give a pale yellow solution and dark solid. The solution was evaporated under vacuum, leaving pale amber liquid. The yield was 44.93 g (98%). ¹H NMR (C₆D₆) δ 2.76 (br s 1H), 1.74 (s, 6H), 1.60 (d, 6H), −0.04 (s, 6H).

### Synthesis of (3-Benz[e]indenyl)dimethyl(tetramethylcyclopentadienyl)silane

To a green solution of dimethyl(tetramethylcyclopentadienyl)silyl trifluoromethanesulfonate (20.00 g, 60.9 mmol, 1.00 equiv) in ether (100 mL) at −35° C. was added in portions lithium benz[e]indenide (11.10 g, 64.5 mmol, 1.06 equiv) to give a cloudy amber-orange mixture. The mixture was stirred 18 hours and then evaporated under vacuum, leaving an orange solid. The solid was extracted with pentane (200 mL, then 3×20 mL) and the extracts filtered to give an amber-orange solution and pink solid. The solution was evaporated under vacuum to give a thick amber-orange oil. The yield was 21.29 g (101%). ¹H NMR (C₆D₆) δ 8.15 (dt, 1H), 7.83 (dt, 1H), 7.59 (q, 2H), 7.49 (dt, 1H), 7.31-7.41 (m, 2H), 6.68 (dd, 1H), 3.82 (br s, 1H), 2.91 (br s, 1H), 1.92 (s, 6H), 1.82 (s, 6H), −0.14 (s, 6H).

### Synthesis of Dilithium [tetramethylcyclopentadienidedimethylsilyl(3 Benz[e]indenide)](etherate)

To an amber-orange solution of (3 Benz[e]indenyl)dimethyl(tetramethylcyclopentadienyl)silane (21.29 g, 61.8 mmol, 1.00 equiv) in ether (100 mL) at −35° C. was added 2.74M butyllithium (46.5 mL, 127 mmol, 2.06 equiv) to give a warm, hazy mixture which quickly became cloudy light brown. The reaction was stirred 17 hours, then pentane (100 mL) was added. The mixture was filtered to give light tan solid and a dark solution. The solid was washed with pentane (40 mL) and dried under vacuum. The yield was 25.54 g (96%). ¹H NMR (THF-d8) δ 8.02 (d, 1H), 7.75 (d, 1H), 7.48 (d, 1H), 7.08 (t, 1H), 6.92 (t, 1H), 6.79 (d, 1H), 6.70 (t, 2H), 3.39 (q, 4H), 2.12 (s, 6H), 1.12 (t, 6H), 0.62 (s, 6H).

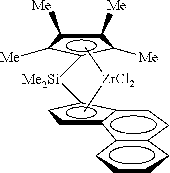

### Synthesis of [Tetramethylcyclopentadienyldimethylsilyl(3-Benz[e]indenyl)]zirconium dichloride

To a vigorously stirred suspension of zirconium tetrachloride bis(etherate) (6.00 g, 15.74 mmol, 1.00 equiv) in ether (100 mL) at −35° C. was added in portions dilithium [tetramethylcyclopentadienidedimethylsilyl(3-Benz[e]indenide)](etherate) (6.78 g, 15.75 mmol, 1.00 equiv) to give a cloudy manila mixture that soon became yellow. The mixture was stirred 21 hours and then evaporated under vacuum, leaving a yellow solid. The solid was extracted with dichloromethane (5×200 mL) and the mixture was filtered to give a yellow solution and tan solid. The solution was evaporated under vacuum to give a yellow solid. The solid was washed with pentane (20 mL) and dried under vacuum. The yield was 7.28 g (92%). ¹H NMR (CD₂Cl₂) δ 8.17 (dt, 1H), 7.79 (dd, 1H), 7.69 (dd, 1H), 7.62 (td, 1H), 7.54 (td, 1H), 7.4 (m, 2H), 6.05 (d, 1H), 2.00 (s, 3H), 1.94 (s, 3H), 1.93 (s, 3H), 1.85 (s, 3H), 1.19 (s, 3H), 0.99 (s, 3H).

### Synthesis of Comparative Catalyst (Catalyst 2):

### Synthesis of Lithium (1-phenylindenide)

To a pale yellow solution of 1-phenylindene (25.25 g, 131 mmol, 1.00 equiv) in pentane (150 mL) was added 2.63M butyllithium in hexanes (50.0 mL, 132 mmol, 1.00 equiv) to give a hazy yellow solution. The mixture became cloudy light yellow with precipitate after stirring 2 hours. The reaction was stirred 42 hours, then filtered to give a light yellow solid and a yellow solution. The solid was washed with pentane (2×40 mL) and dried under vacuum. The yield was 24.07 g (92%) light yellow powder. ¹H NMR (THF-d8) δ 7.72 (d, 1H), 7.55 (d, 2H), 7.19 (d, 1H), 7.01 (m, 2H), 6.85 (d, 1H), 6.51 (t, 1H), 6.46 (t, 1H), 6.36 (t, 1H), 5.93 (d, 1H).

### Synthesis of Dimethyl(3-phenylindenyl)(tetramethylcyclopentadienyl)silane

To a yellow-green solution of chlorodimethyl(tetramethylcyclopentadienyl)silane (5.00 g, 23.3 mmol, 1.00 equiv) in ether (25 mL) at −35° C. was added lithium (1-phenylindenide) (4.85 g, 24.5 mmol, 1.05 equiv) to give a yellow solution. The reaction quickly became cloudy greenish-white. The mixture was allowed to warm to room temperature and was stirred 23 hours. The reaction was then evaporated under vacuum, leaving a sticky residue. The residue was extracted with pentane (40 mL) and filtered to give an amber solution and greenish-white solid. The solution was evaporated under vacuum to give a thick amber oil. The yield was 7.07 g (82%). ¹H NMR (C₆D₆) δ 7.73 (d, 1H), 7.64 (d, 2H), 7.48 (d, 1H), 7.31-7.19 (m, 5H), 6.59 (s, 1H), 3.69 (d, 1H), 2.92 (br s, 1H), 1.93 (s, 3H), 1.90 (s, 3H), 1.82 (s, 3H), 1.81 (s, 3H), −0.09 (s, 3H), −0.39 (s, 3H).

### Synthesis of Dilithium [tetramethylcyclopentadienidedimethylsilyl(3-phenylindenide)](etherate)

To a yellow solution of dimethyl(3-phenylindenyl)(tetramethylcyclopentadienyl)silane (7.03 g, 19.0 mmol, 1.00 equiv) in ether (25 mL) at −35° C. was added 2.63M butyllithium in hexanes (14.8 mL, 38.9 mmol, 2.05 equiv) to give a warm, yellow solution that quickly became cloudy yellow with precipitate. The mixture was allowed to warm to room temperature and was stirred 20 hours. The reaction was then filtered to give a yellow solid and a yellow solution. The solid was washed with pentane (2×40 mL) and dried under vacuum. The yield was 8.51 g (97%) yellow powder. ¹H NMR (THF-d8) δ 7.70 (d, 1H), 7.53 (m, 3H), 7.12 (s, 1H), 7.03 (t, 2H), 6.57 (t, 1H), 6.48 (t, 1H), 6.41 (t, 1H), 3.39 (q, 4.36H), 2.20, (s, 6H), 1.91 (s, 6H), 1.13 (t, 6.51H), 0.64 (br s, 6H).

### Synthesis of [Tetramethylcyclopentadienyldimethylsilyl(3-phenylindenyl)]zirconium dichloride

To a vigorously stirred white suspension of zirconium tetrachloride bis(etherate) (2.00 g, 5.25 mmol, 1.00 equiv) in ether (35 mL) at −35° C. was added dilithium [tetramethylcyclopentadienidedimethylsilyl(3-phenylindenide)](etherate) (2.43 g, 5.24 mmol, 1.00 equiv) to give a cloudy manila-yellow mixture. The reaction quickly became bright yellow and thick with precipitate. The mixture was stirred 16 hours, then evaporated under vacuum, leaving yellow solid. The solid was extracted with dichloromethane (50 mL, then 3×10 mL) and the extracts filtered to give a bright yellow solution and yellow-white solid. The solution was evaporated under vacuum, leaving yellow-orange solid. The resulting solid was washed with pentane (2×20 mL) and dried under vacuum. The yield was 2.53 g (91%) bright yellow powder. ¹H NMR (CD₂Cl₂) δ 7.90 (d, 1H), 7.60 (m, 3H), 7.49 (m, 2H), 7.42-7.36 (m, 2H), 7.10 (m, 1H), 6.00 (s, 1H), 2.00 (s, 3H), 1.96 (s, 3H), 1.92 (s, 3H), 1.89 (s, 3H), 1.23 (s, 3H), 1.00 (s, 3H).

### Procedure of Supportation of Catalyst 1:

MAO (0.84 g in 30 Wt % in toluene) was added to the celestir along with 50 ml of toluene. The solution was allowed to stir for two minutes. The catalyst was dissolved in 15 ml of toluene and added slowly drop by drop to the MAO solution. The reaction mixture was allowed to stir for an hour at room temperature. Then ES70 875 silica (0.76 g) was added to the above mixture and stir for another hour. The solid support was filtered and washed with 50 ml of pentane. Then the supported catalyst was dried under vacuum for 3 hours yield a gram of support.

### Polymerization:

Polymerization was performed in a 7 foot tall gas-phase fluidized bed reactor with a 4 foot tall 6″ diameter body and a 3 foot tall 10″ diameter expanded section. Cycle and feed gases were fed into the reactor body through a perforated distributor plate, and the reactor was controlled at 300 psi and 70 mol % ethylene. Reactor temperature was maintained by heating the cycle gas. Supported catalyst was fed as a 10 wt % slurry in Sono Jell® from Sonneborn (Parsippany, NJ). Supported catalyst 1 (Examples 1-3) or catalyst 2 (Comparative 1-2) was delivered to the reactor as a slurry by nitrogen and isopentane feeds in a ⅛″ diameter catalyst probe. Polymer was collected from the reactor as necessary to maintain the desired bed weight. Average process conditions for the polymer collection are shown in Table 1.

TABLE 1

| Description | Example 1 | Example 2 | Example 3 | Comparative 1 | Comparative 2 |
|---|---|---|---|---|---|
| Catalyst | Catalyst 1 | Catalyst 1 | Catalyst 1 | Catalyst 2 | Catalyst 2 |
| H2 conc. (molppm) | 2268 | 1278 | 3305 | 475 | 125 |
| C6/C2 Ratio (mol %/mol %) | 0.011 | 0.012 | 0.017 | 0.024 | 0.024 |
| Comonomer conc. (mol %) | 0.77 | 0.84 | 1.20 | 1.71 | 1.68 |
| C2 conc. (mol %) | 69.4 | 70.0 | 69.8 | 70.0 | 69.9 |
| Comonomer/C2 Flow Ratio | 0.054 | 0.057 | 0.079 | 0.084 | 0.082 |
| H2/C2 Ratio | 32.7 | 18.3 | 47.3 | 6.8 | 1.8 |
| Rx. Pressure (psig) | 300 | 300 | 300 | 300 | 300 |
| Reactor Temp (F) | 179.5 | 179.4 | 179.2 | 179.6 | 179.6 |
| Residence Time (hr) | 3.2 | 3.4 | 3.8 | 4.6 | 6.2 |
| Catalyst Feed (g/hr) | 0.142 | 0.141 | 0.147 | 0.183 | 0.186 |
| Cat Activity (g poly/g cat) | 4854 | 4847 | 4309 | 2697 | 1985 |
| Bulk Density | 0.3669 | 0.4097 | 0.3409 | 0.3707 | 0.3918 |

### Production Performance:

Resin, rheology and processing properties are given in Tables 2a and 2b. Molecular weight data was obtained from GPC-4D. Composition Distribution Breadth Index (CDBI), defined to be the percent of polymer whose composition is within 50% of the median comonomer composition, was obtained from CryoTREFIR5 instrument. Rheological data were from SAOS experiment, and from which, Shear Thinning Index 0.1/100, defined as the ratio of complex viscosities at 0.1 and 100 rad/s, were obtained. Comparative 3 is Exceed™ 1018 (a metallocene-catalyzed LLDPE with substantially no LCB), available from ExxonMobil™ Product Solutions Company of Spring, TX. Comparative 4 is LDPE LD103.09 available from ExxonMobil™ Product Solutions Company of Spring, TX. Comparative 5 is LDPE LD105.30 available from ExxonMobil™ Product Solutions Company of Spring, TX. Comparative 6 is LDPE LD 051 available from ExxonMobil™ Product Solutions Company of Spring, TX. Each LDPE is a polyethylene homopolymer produced in a high-pressure, free-radical polymerization process known for producing highly branched non-linear polymers.

An extrusion exercise was also done on a small lab extruder with a 2″ screw of 30 L/D ratio. Table 3 presents methods used for analyses.

TABLE 2a

| Description | Example 1 | Example 2 | Example 3 |
|---|---|---|---|
| Density, g/cm³ | 0.9251 | 0.9198 | 0.9148 |
| MI, g/10 min | 1.04 | 0.20 | 5.83 |
| HLMI, g/10 min | 128.4 | 29.4 | 271.60 |
| MIR | 123.8 | 144.9 | 46.59 |
| Hexene wt % | 8.38 | 9.06 | 11.9 |
| Mz(LS), Daltons | 632229 | 927835 | 519305 |
| Mw(LS), Daltons | 127840 | 218323 | 99886 |
| Mn(LS), Daltons | 10661 | 18204 | 10479 |
| PDI | 12.0 | 12.0 | 9.53 |
| LCB -g′(vis avg) | 0.69 | 0.64 | 0.73 |
| CDBI-50% | 71.1 | 71.0 | 73.9 |
| STI(0.1/100 rad/s) | 26.2 | 51.3 | 11.2 |
| Phase angle at 10 kPa, degree | 46.6 | 42.5 | 52.2 |
| Screw speed, rpm | 30 | 30 | — |
| Die pressure, psi | 1280 | 2560 | — |
| Motor load, % | 33 | 41 | — |

TABLE 2b

| Description | Comp. 1 | Comp 2 | Comp. 3 | Comp. 4 | Comp. 5 | Comp 6 |
|---|---|---|---|---|---|---|
| Density, | 0.9207 | 0.9135 | 0.9180 | 0.9201 | 0.9240 | 0.9210 |
| g/cm³ | | | | | | |
| MI, g/10 min | 1.60 | 0.30 | 1.00 | 1.03 | 2.10 | 0.24 |
| HLMI, | 76.1 | 26.40 | 16.5 | 59.2 | 109.2 | 25.2 |
| g/10 min | | | | | | |
| MIR | 47.5 | 88.8 | 16.5 | 57.8 | 52.0 | 105 |
| Hexene | 9.98 | 11.78 | 6.3 | ~ | ~ | ~ |
| wt % | | | | | | |
| Mz(LS), | 1846725 | 1916022 | 183,667 | 714,257 | 21930 | 1558112 |
| Daltons | | | | | | |
| Mw(LS), | 151947 | 202032 | 113,502 | 213,387 | 121209 | 305035 |
| Daltons | | | | | | |
| Mn(LS), | 15864 | 18006 | 41,611 | 23,737 | 354037 | 20509 |
| Daltons | | | | | | |
| PDI | 9.58 | 11.22 | 2.73 | 8.99 | 5.53 | 14.9 |
| LCB -g′(vis | 0.73 | 0.70 | 1.01 | 0.39 | 0.487 | 0.36 |
| avg) | | | | | | |
| CDBI-50% | 46.9 | 62.9 | 60.2 | ~ | ~ | ~ |
| STI(0.1/100 | 15.1 | 33.8 | 2.8 | 23.6 | 13.3 | 52.1 |
| rad/s) | | | | | | |
| Phase angle | 53.6 | 49.3 | 83.5 | 50.7 | 57.0 | 44.6 |
| at 10 kPa, | | | | | | |
| degree | | | | | | |
| Screw | 30 | — | 30 | — | — | — |
| speed, rpm | | | | | | |
| Die | 1650 | — | 4250 | — | — | — |
| pressure, psi | | | | | | |
| Motor load, | 36 | — | 54 | — | — | — |
| % | | | | | | |

TABLE 3

| Test Name | Method |
|---|---|
| Melt Index (MI) | ASTM D-1238 2.16 kg (190 °C) (I₂) or (I_{2.16}) |
| High Load Melt Index (HLMI) | ASTM D-1238 21.6 kg (190 °C) (I₂₁) or (I_{21.6}) |
| Melt Index Ratio (MIR) | I₂₁/I₂ |
| Density | ASTM D1505, column density. Samples were molded under |
| | ASTM D4703-10a, Procedure C, then conditioned under ASTM |
| | D618-08 (23° ± 2 °C and 50 ± 10% Relative Humidity) for 40 |
| | Hours before testing |
| 1% Secant Modulus | Modified ASTM D-882, sample conditioning*, 1″ strip, 4″ length |
| Yield Strength | Modified ASTM D-882, sample conditioning*, 1″ strip, 4″ |
| | sample length |
| Tensile Strength | Modified ASTM D-882, sample conditioning*, 1″ strip, 4″ |
| | sample length |
| Elongation at Break | Modified ASTM D-882, sample conditioning*, 1″ strip, 4″ |
| | sample length |
| Elongation at Yield | Modified ASTM D-882, sample conditioning*, 1″ strip, 4″ |
| | sample length |
| Dart Drop | Modified ASTM D-1709, Phenolic, Method A. Sample |
| | conditioning in the lab, calculation uses last 10 passes |
| | and 10 fails |
| Haze | ASTM D-1003 |
| Gloss, 45° | ASTM D-2457 |
| Elmendorf Tear | ASTM D1922 with ASTM Conditioning for 40 Hours at 23° ± |
| | 2 °C and 50 ± 10% Relative Humidity |
| Puncture | Modified ASTM D5748. EXXONMOBIL probe was used with |
| | two 0.25 mil HDPE slip sheets. Machine Model: United SFM-1. |
| | Testing speed: 10 in/min. |
| ¹HNMR | Unsaturations in a polymer and specifically percent internal |
| | unsaturation are determined by ¹H NMR with reference to 38 |
| | MACROMOLECULES 6988 (2005), and 47 MACROMOLECULES |
| | 3782 (2014). (see ¹H NMR section) |
| Heat Seal | 1 inch film strip of 1 mil gauge, sealed at various temperatures |
| | under 73 psi (0.5N/mm²) for 1 second. Following ASTM |
| | Conditioning for 40 Hours at 23° ± 2 °C and 50 ± 10% Relative |
| | Humidity, the sealed specimen were tested in T-joint peel mode |
| | at 20 inch/min pulling speed. |
| Hot tack | 1 inch film strip of 1 mil gauge, sealed at various temperatures |
| | under 73 psi (0.5N/mm²) for 0.5 second. After a 0.4 second |
| | delay, the sealed specimen were pulled at 200 mm/speed in T- |
| | joint peel mode. |

*the samples are cut from the rolls, placed between sheets of paper, and then placed on the counter before testing. Samples conditioned according to ASTM for 40 hours at 23° ± 2 °C and 50 ± 10% Relative Humidity.
** Tensile strength refers to the maximum strength reached, most often occurs at sample break. Yield occurs early in the testing where the load reaches a local maximum. For PE, most times yield strength will be surpassed by tensile strength later in deformation, but sometimes sample breaks soon after yield without any strengthening, then yield strength and the tensile strength are the same.

TABLE 4

| Catalyst | Example 1 | Example 2 |
|---|---|---|
| I₂ (g/10 min) | 1.04 | 0.20 |
| I₂₁ (g/10 min) | 128.4 | 29.4 |
| MIR | 123.8 | 144.9 |
| Films made and testing | | |
| Die Gap (mil) | 60 | 60 |
| Melt (°F) | 284 | 307 |
| Head Pressure (psi) | 1280 | 2560 |
| % motor load | 33 | 41 |
| RPM | 30 | 30 |
| % air | 64 | 77 |
| Line Speed (fpm) | 110 | — |
| Film Thickness | | |
| Low | 0.524 | 0.736 |
| High | 1.334 | 1.296 |
| Film Std Dev | 0.226 | 0.158 |
| Average | 1.029 | 1.038 |
| 1% Secant (psi) [MD/TD] | 0.89 | 0.75 |
| MD | 37609 | 29880 |
| TD | 42156 | 39853 |
| AVG | 39882 | 34867 |
| Tensile Yield Strength (MD) (psi) | 1523 | 1486 |
| Tensile Yield Strength (TD) (psi) | 2021 | 1480 |
| Elongation @ Yield - MD (%) | 5.09 | 5.99 |
| Elongation @ Yield - TD (%) | 4.69 | 4.66 |
| Tensile Strength - MD (psi) | 3282 | 4803 |
| Tensile Strength - TD (psi) | 3603 | 4489 |
| Elongation @ Break - MD (%) | 369 | 361 |
| Elongation @ Break - TD (%) | 557 | 606 |
| Elmendorf Tear | | |
| MD (g) | 93.8 | 74.7 |
| TD (g) | 388.3 | 193.5 |
| MD (g/mil) | 96.9 | 72.2 |
| TD (g/mil) | 378.8 | 191.8 |
| MD/TD | 0.26 | 0.38 |
| Dart Drop, Phenolic (g) | 68 | 135 |
| Dart Drop, Phenolic (g/mil) | 52 | 138 |
| Puncture (Probe B) | | |
| Peak Force (lbs) | 7.9 | 8.0 |
| Peak Force (lbs/mil) | 7.7 | 7.7 |
| Break Energy (in-lbs) | 12.6 | 11.4 |
| Break Energy (in-lbs/mil) | 12.3 | 10.9 |
| Haze (%) | 22.7 | >30 |
| Haze- internal (%) | 2.9 | 2.1 |
| Clarity (%) | 80.8 | 35.1 |
| Blocking (I/I), g | 4.5 | 3 |
| Shrink_MD | 69 | 72 |
| Shrink_TD | 1 | 0 |

### Film Production

Blown film evaluations of the polymers as prepared and described above were carried out on a 2″ extruder equipped with a 2″ spiral mandrel die operated at a die throughput rate of 8 lbs/hr/die inch using a melt temperature of 370° F.-380° F. and 3.0 BUIR. Film properties at 1.0 mil gauge are summarized above in Table 4.

TDA is the total defect area. It is a measure of defects in a film specimen and reported as the accumulated area of defects in square millimeters (mm²) normalized by the area of film in square meters (in²) examined, thus having a unit of (mma/m²) or “ppm” ~. In Table 6, only defects with a dimension above 200 microns are reported.

TDA is obtained by an Optical Control System (OCS). This system consists of a small extruder (MVE20 2800), cast film die, chill roll unit (Model CR-9), a winding system with good film tension control, and an on-line camera system (Model FSA-100) to examine the cast film generated for optical defects. The typical testing condition for the cast film generation is: extruder temperature setting (° C.): Feed throat/Zone 1/Zone 2/Zone 3/Zone4/Die: 70/190/200/210/215/215; extruder speed: 50 rpm; chill roll temperature: 30° C.; chill roll speed: 3.5 m/min

The system generates a cast film of about 4-5 inches in width and a nominal gauge of 1 mil. Melt temperature varies with materials, and can be around 215° C.

The polyethylene composition has a broad MIR (e.g., 46.6 to about 150); a g′_{vis ave} of 0.64 to 0.73; indicating substantially more long-chain branching than in the metallocene-catalyzed LLDPE, although still less branching than the traditional LDPEs (which frequently have g′_{vis ave} values of ~0.36 to 0.49); a CDBI from 71 to 73.9, higher than comparative 1 and 2 (indicating a more even distribution of comonomer among polymer chains of different lengths); and very strong shear-thinning characteristics as compared to the gas-phase LLDPE comparatives 1-3 and the high-pressure LDPE comparatives 4-6 (e.g., as seen in the relatively high STI_{0.1/100} values of Examples 1-2). Additionally, examples 1-3 had better rheology characteristics (Van Gurp Plot), lower phase angle (at 10 kPa Complex Modulus) values than gas phase comparatives 1-3 and high pressure Comparatives 4-6, and very low die pressure and motor loads compared to comparative mLLDPEs 1 and 3, indicating substantially better processing.

The film demonstrated good shrink values, as shown above in Table 4.

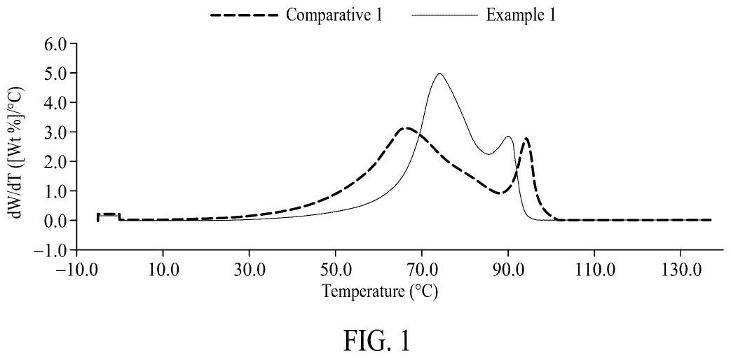

FIG. 1 is a graph illustrating a TREFIR5 of polyethylene copolymers synthesized from Catalyst 1 compared to polyethylene copolymers synthesized from comparative catalysts.

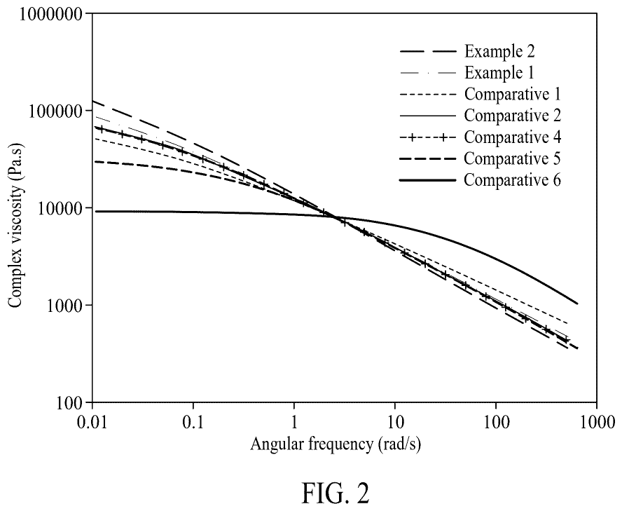

FIG. 2 is a graph illustrating a complex viscosity of polyethylene copolymers synthesized from Catalyst 1 compared to polyethylene copolymers synthesized from comparative catalysts.

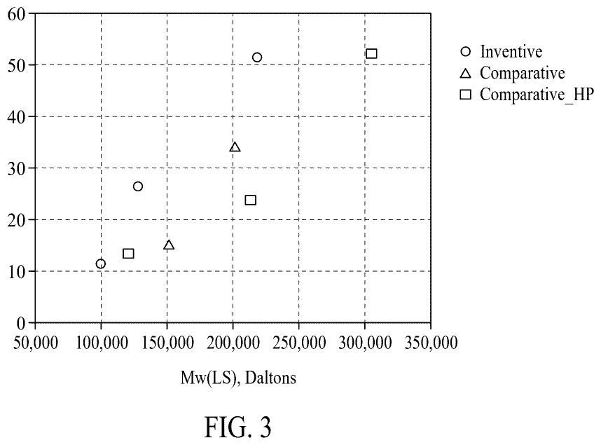

FIG. 3 is a graph illustrating a shear thinning index of polyethylene copolymers synthesized from Catalyst 1 compared to polyethylene copolymers synthesized from comparative catalysts.

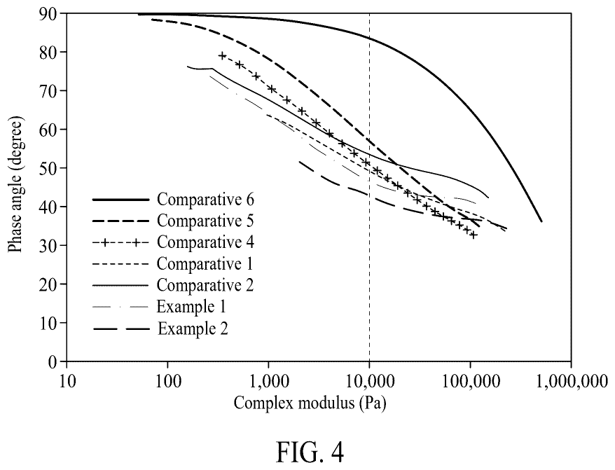

FIG. 4 is a graph illustrating a phase angle vs complex modulus of polyethylene copolymers synthesized from Catalyst 1 compared to polyethylene copolymers synthesized from comparative catalysts.

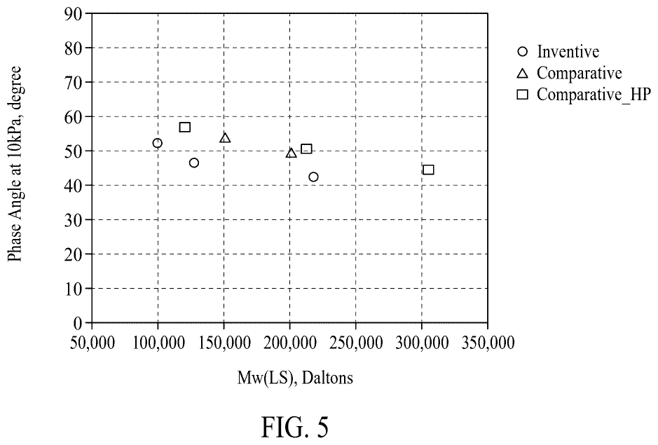

FIG. 5 is a graph illustrating a phase angle (at 10 kPa) of polyethylene copolymers synthesized from Catalyst 1 compared to polyethylene copolymers synthesized from comparative catalysts.

Overall, the processes, catalysts, and films of the present disclosure can provide a polyethylene polymer having BOCD formed in a low pressure (gas phase) reactor from a single supported catalyst. The low pressure provides reduced energy input to the reactor when forming polyethylene polymers. The low pressure single catalyst process produces LCB, CDBI, strong shear thinning, STI_{0.1/100}, rheological characteristics, lower phase angle, and very low die pressure and motor load when compared to conventional LDPEs and/or LLDPEs.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including”. Likewise, whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

1. A catalyst compound represented by Formula (I): 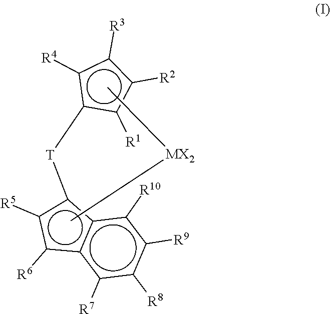
wherein:
M is Zr or Hf,
R⁵ and R⁶ are each hydrogen;
each of R¹, R², R³, and R⁴ is independently hydrogen or substituted or unsubstituted C₁ to C₁₀ alkyl;
one of (1) R⁷ and R⁸, (2) R⁸ and R⁹, or (3) R⁹ and R¹⁰ are joined to form a substituted or unsubstituted aromatic ring or saturated ring fused to the indenyl ring shown in Formula (I), and the remainder of R⁷, R⁸, R⁹, and R¹⁰ are each hydrogen;
T is represented by formula R^{a}₂J, (R^{a})₄J₂, or (R^{a})₆J₃ wherein each J is independently carbon, silicon, or germanium, and each R^{a} is independently hydrogen, halide, a substituted or unsubstituted C₁ to C₄₀ hydrocarbyl, wherein two R^{a} optionally can form a substituted or unsubstituted completely saturated ring, a substituted or unsubstituted partially saturated ring, or a substituted or unsubstituted aromatic ring; and
each X is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene.

2. The catalyst compound of claim 1, wherein M is Zr or Hf; X is C₁-C₄ alkyl; and T is SiMe₂, SiEt₂, or SiMeEt.

3. The catalyst compound of claim 2, wherein:
(i) R⁹ and R⁸ are joined to form a substituted or unsubstituted cyclopentyl ring fused to the indenyl ring of Formula (I);
(ii) R⁷ and R¹⁰ are each hydrogen; and
(iii) R¹, R², R³, and R⁴ are each independently C₁-C₄ alkyl.

4. The catalyst compound of claim 2, wherein the catalyst compound is:

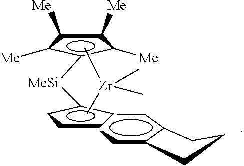

5. The catalyst compound of claim 1, wherein the catalyst compound is represented by Formula (II): 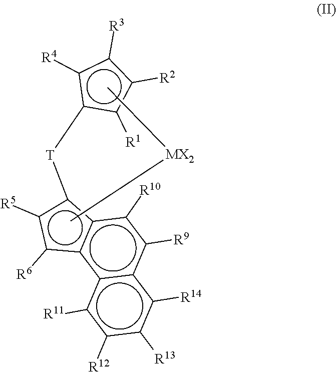
wherein:
M of Formula (II) is zirconium;
R⁵-R¹⁴ are each hydrogen;
each of R¹, R², R³, and R⁴ is independently hydrogen or substituted or unsubstituted C₁ to C₁₀ alkyl; T of Formula (II) is represented by the formula R^{a}₂J, (R^{a})₄J₂, or (R^{a})₆J₃ wherein each J is independently C, Si, or Ge, and each R^{a} is independently hydrogen, halide, a substituted or unsubstituted C₁ to C₄₀ hydrocarbyl, or two R^{a} can form a substituted or unsubstituted cyclic structure including a substituted or unsubstituted completely saturated ring, a substituted or unsubstituted partially saturated ring, or a substituted or unsubstituted aromatic ring; and
each X of Formula (II) is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene.

6. The catalyst of claim 5, wherein X is halide; T is SiMe₂, SiEt₂, or SiMeEt; and each of R¹, R², R³, and R⁴ is C₁ to C₄ alkyl.

7. The catalyst compound of claim 6, wherein the catalyst compound is represented by the structure:

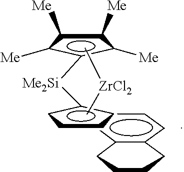

8. A process for producing a polyethylene composition, comprising:
introducing, under first polymerization conditions, ethylene and a C₃-C₄₀ alpha-olefin with a catalyst system in a reactor, and forming a polyethylene copolymer with ethylene monomer derived content and C₃-C₄₀ alpha-olefin comonomer derived content, wherein the catalyst system comprises:
a catalyst compound, wherein the catalyst compound is represented by Formula (I): 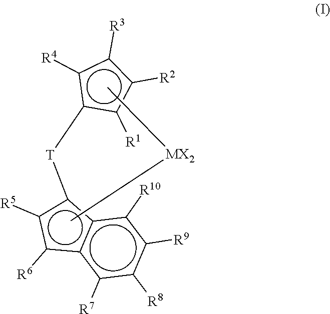
wherein:
M is a group 4 metal;
R⁶ is hydrogen;
each of R¹, R², R³, R⁴, R⁵, R⁷, R⁸, R⁹, and R¹⁰ is independently hydrogen, a substituted or unsubstituted hydrocarbyl, a substituted or unsubstituted heteroatom, or a substituted or unsubstituted heteroatom-containing group, or one or more of R⁵ and R⁶, R⁷ and R⁸, R⁸ and R⁹, and R⁹ and R¹⁰ are joined to form a substituted or unsubstituted completely saturated ring or a substituted or unsubstituted aromatic ring, wherein at least one of (1) R⁷ and R⁸, (2) R⁸ and R⁹, or (3) R⁹ and R¹⁰ are joined to form a substituted or unsubstituted aromatic ring fused to the indenyl ring shown in Formula (I);
T is represented by formula R^{a}₂J, (R^{a})₄J₂, or (R^{a})₆J₃ wherein each J is independently carbon, silicon, or germanium, and each R^{a} is independently hydrogen, halide, a substituted or unsubstituted C₁ to C₄₀ hydrocarbyl, or two R^{a} can form a substituted or unsubstituted completely saturated ring, a substituted or unsubstituted partially saturated ring, or a substituted or unsubstituted aromatic ring; and
each X is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene.

9. The process of claim 8, wherein in the catalyst compound, at least one of (1) R⁷ and R⁸, (2) R⁸ and R⁹, or (3) R⁹ and R¹⁰ are joined to form a substituted or unsubstituted aromatic or saturated ring fused to the indenyl ring shown in Formula (I).

10. The process of claim 8, wherein in the catalyst compound:
T is selected from the group consisting of SiMe₂, SiEt₂, and SiMeEt;
each of R¹, R², R³, and R⁴ of Formula (I) is methyl;
M is zirconium; and
each X is independently methyl or a halide.

11. The process of claim 10, wherein the catalyst compound is represented by either of the following structures (I-a) or (I-c), or by their analogues having ZrMe₂ in place of ZrCl₂:

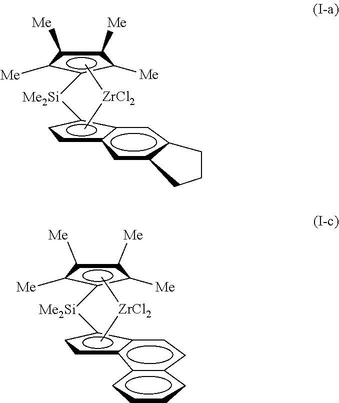

12. The process of claim 8, wherein the polymerization conditions comprise:
a reactor pressure of about 250 psig to about 350 psig;
a reactor temperature of about 60° C. to about 110° C.; and
optionally, a H2/C2 ratio greater than 10.

13. The process of claim 8, wherein the polyethylene copolymer has olefin comonomer derived content of about 7 wt % to about 12 wt %, on the basis of total mass of the olefin comonomer derived content and ethylene monomer derived content, and furthermore has one or more of the following properties:
(a) a density of about 0.914 g/cm³ to about 0.926 g/cm³,
(b) a melt index of about 0.10 g/10 min to about 6 g/min;
(c) a high load melt index (HLMI) of about 120 g/10 min to about 275 g/10 min;
(d) a melt index ratio (MIR) of about 60 to about 150; and
(e) a molecular weight distribution (MWD, Mw/Mn) of about 9 to about 15.

14. The process of claim 13, wherein the polyethylene copolymer has all of the properties (a)-(e).

15. The process of claim 13, wherein the polyethylene copolymer further has a composition breadth index (CDBI) of about 70% to about 80%.

16. The process of claim 8, wherein the polyethylene copolymer is characterized by having long chain branching (LCB).

17. The process of claim 16, wherein the LCB of the polyethylene copolymer is characterized by one or more of the following:
(a) a g′vis value of the polyethylene copolymer of about 0.6 to about 0.8;
(b) a phase angle at 10 kPa of about 40 to about 55 degrees within a molecular weight range of about 100,000 to about 250,000 Daltons; or
(c) a zero-shear rate viscosity between about 100,000 and about 1,000,000 Pa, and a shear thinning index STI(0.1/100) of about 10 to about 60 within a molecular weight range of about 100,000 to about 250,000 Daltons.

18. A film comprising a polyethylene copolymer, comprising:
90 wt % or greater ethylene units; and
a remainder balance of C₃-C₂₀ comonomer units;
the polyethylene copolymer having:
a CDBI of about 70% to about 80%,
a density of about 0.914 g/cm³ to about 0.926 g/cm³,
a melt index of about 0.10 g/10 min to about 6 g/10 min,
an olefin comonomer content of about 7 wt % to about 12 wt %,
a high load melt index (HLMI) of about 120 g/10 min to about 275 g/10 min,
a melt index ratio (MIR) of about 60 to about 150, and
a molecular weight distribution (MWD) of about 9 to about 13.

19. The film of claim 18, wherein the polyethylene copolymer has one or more of the following:
(i) a g′vis value of about 0.6 to about 0.8;
(ii) a phase angle at 10 kPa of about 40 to about 55 degrees within a molecular weight range of about 100,000 to about 250,000 Daltons; or
(iii) a zero-shear rate viscosity between about 100,000 and about 1,000,000 Pa, and a shear thinning index STI(0.1/100) of about 10 to about 60 within a molecular weight range of about 100,000 to about 250,000 Daltons.
